(19) United States
(12) Patent Application Publication
(10) Pub. No.: US 2025/0370751 A1
(43) Pub. Date: Dec. 4, 2025

(54) METHOD, APPARATUS, AND DEVICE, AND STORAGE MEDIUM FOR SCHEDULING INSTRUCTION

(71) Applicant: TENCENT TECHNOLOGY (SHENZHEN) COMPANY LIMITED, Shenzhen (CN)

(72) Inventors: Hua TIAN, Shenzhen (CN); Kai YAN, Shenzhen (CN); Ran XIAO, Shenzhen (CN); Ronglin JIANG, Shenzhen (CN)

(21) Appl. No.: 19/297,435

(22) Filed: Aug. 12, 2025

Related U.S. Application Data
(63) Continuation of application No. PCT/CN2024/104203, filed on Jul. 8, 2024.

(30) Foreign Application Priority Data
Aug. 18, 2023 (CN) 202311045441.9

(51) Int. Cl. G06F 9/30

(52) U.S. Cl. CPC G06F 9/3009

(57) ABSTRACT

A method for scheduling an instruction includes acquiring a first instruction sequence including N instructions and scheduling information being a scheduling parameter required for performing a scheduling operation on the N instructions; performing breadth search processing on the scheduling information and first M instructions among the N instructions based on a breadth search algorithm, to obtain L sub-scheduling sets, each sub-scheduling set comprising scheduling results of the first M instructions, and 1≤M<N; performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and generating a target code program based on the target scheduling results, the target code program being configured for scheduling the instructions.

### CROSS-REFERENCES TO RELATED APPLICATIONS

This application is a continuation application of PCT Patent Application No. PCT/CN2024/104203, filed on Jul. 8, 2024, which claims the priority to Chinese Patent Application No. 202311045441.9, filed on Aug. 18, 2023, all of which is incorporated by reference in its entirety.

### FIELD OF THE TECHNOLOGY

Embodiments of the present disclosure relate to the technical field of compilation, and in particular, to instruction scheduling.

### BACKGROUND OF THE DISCLOSURE

In recent years, rapid development of artificial intelligence (AI) has brought technical transformations to various fields, such as natural language processing, computer vision, e-commerce, intelligent cities, and drug discovery. To construct a complete application ecosystem, it has been critical to design and develop an AI-matched tool chain, especially an AI compiler. The AI compiler typically combines a front-end structure and a back-end structure to connect an AI model generated through a machine learning framework with an underlying hardware chip. In a process of back-end code generation of the AI compiler, instructions are generally scheduled based on a software pipelining algorithm such as a modulo scheduling algorithm, to generate a corresponding target code program.

However, in a modulo scheduling algorithm, an instruction sequence transmitted from the front-end structure is generally scheduled directly based on a backtracking search algorithm. During the scheduling process, a core loop will be expanded multiple times. Consequently, the number of instructions in the core loop will be continuously multiplied along with an increase in the number of expansions, and an instruction search space is also exponentially expanded. However, when the instructions are scheduled according to a backtracking search algorithm, backtracking adjustment is only focused on an instruction close to a failed scheduling, which limits ability to expand the search space for instructions for instruction scheduling, resulting in poor scheduling performance. In addition, the backtracking search algorithms are not a type of parallel algorithms and cannot increase a scheduling speed.

### SUMMARY

One embodiment of the present disclosure provides a method for scheduling an instruction. The method includes acquiring a first instruction sequence and scheduling information, the first instruction sequence including N instructions, the scheduling information being a scheduling parameter required for performing a scheduling operation on the N instructions, and N being a positive integer; performing breadth search processing on the scheduling information and first M instructions among the N instructions based on a breadth search algorithm, to obtain L sub-scheduling sets, each sub-scheduling set including scheduling results of the first M instructions, L being a positive integer, and 1≤M<N; performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and generating a target code program based on the target scheduling results, the target code program being configured for scheduling the instructions.

Another embodiment of the present disclosure provides a device. The device includes an input/output interface, one or more processors, and a memory containing a computer program that, when being executed, causes the one or more processors to perform: acquiring a first instruction sequence and scheduling information, the first instruction sequence including N instructions, the scheduling information being a scheduling parameter required for performing a scheduling operation on the N instructions, and N being a positive integer; performing breadth search processing on the scheduling information and first M instructions among the N instructions based on a breadth search algorithm, to obtain L sub-scheduling sets, each sub-scheduling set including scheduling results of the first M instructions, L being a positive integer, and 1≤M<N; performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and generating a target code program based on the target scheduling results, the target code program being configured for scheduling the instructions.

Another embodiment of the present disclosure provides a non-transitory computer-readable storage medium containing a computer program that, when being executed, causes at least one processor of a computer device to perform: acquiring a first instruction sequence and scheduling information, the first instruction sequence including N instructions, the scheduling information being a scheduling parameter required for performing a scheduling operation on the N instructions, and N being a positive integer; performing breadth search processing on the scheduling information and first M instructions among the N instructions based on a breadth search algorithm, to obtain L sub-scheduling sets, each sub-scheduling set including scheduling results of the first M instructions, L being a positive integer, and 1≤M<N; performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and generating a target code program based on the target scheduling results, the target code program being configured for scheduling the instructions.

### BRIEF DESCRIPTION OF THE DRAWINGS

FIG. 1 is a schematic diagram of an overall architecture of an artificial intelligence (AI) compiler;

FIG. 2A is a schematic structural diagram of a modulo scheduling algorithm;

FIG. 2B is a schematic flowchart of a modulo scheduling algorithm;

FIG. 3A is a schematic diagram of a system architecture according to an embodiment of the present disclosure;

FIG. 3B is a schematic diagram of a scheduling flow of a fused search solution according to an embodiment of the present disclosure;

FIG. 4 is a flowchart of a method for scheduling an instruction according to an embodiment of the present disclosure;

FIG. 5 is a schematic diagram of an unranked instruction sequence according to an embodiment of the present disclosure;

FIG. 6 is a schematic structural diagram of a directed acyclic graph according to an embodiment of the present disclosure;

FIG. 7 is a schematic diagram of a ranked first instruction sequence according to an embodiment of the present disclosure;

FIG. 8A is a flowchart of first-type processing of a breadth search according to an embodiment of the present disclosure;

FIG. 8B is a schematic diagram of a sub-scheduling set according to an embodiment of the present disclosure;

FIG. 8C is a flowchart of second-type processing of a breadth search according to an embodiment of the present disclosure;

FIG. 9A is a flowchart of first-type processing of a backtracking search according to an embodiment of the present disclosure;

FIG. 9B is a schematic diagram of a target scheduling result according to an embodiment of the present disclosure;

FIG. 9C is a flowchart of second-type processing of a backtracking search according to an embodiment of the present disclosure;

FIG. 10 is a schematic diagram of modulo scheduling information according to an embodiment of the present disclosure;

FIG. 11 is a schematic diagram of an instruction sequence of a core loop according to an embodiment of the present disclosure;

FIG. 12 is a schematic diagram of comparison between a scheduling number of a scheduling solution of the present disclosure and a scheduling number of a conventional search solution;

FIG. 13 is a schematic diagram of another embodiment of a scheduling solution of the present disclosure;

FIG. 14 is a schematic diagram of an embodiment of an apparatus for scheduling an instruction according to an embodiment of the present disclosure; and

FIG. 15 is a schematic structural diagram of a hardware of a device for scheduling an instruction according to an embodiment of the present disclosure.

### DESCRIPTION OF EMBODIMENTS

A method, apparatus, and device for scheduling an instruction, a storage medium, and a program product are provided in embodiments of the present disclosure. Thus, an instruction search space can be expanded, scheduling performance can be improved, and an instruction scheduling speed can be increased.

In the particular implementation of the present disclosure, relevant data such as user information are involved. When the above embodiments of the present disclosure are applied to a particular product or technology, the permission or consent of a user is required, and collection, use, and processing of the relevant data need to comply with relevant laws, regulations, and standards of relevant countries and regions.

The technical solution in the embodiments of the present disclosure is clearly and completely described below with reference to the accompanying drawings in the embodiments of the present disclosure. Apparently, the embodiments described are merely some embodiments rather than all embodiments of the present disclosure. All other embodiments derived by those of ordinary skill in the art based on the embodiments of the present disclosure without creative efforts fall within the scope of protection of the present disclosure.

The terms such as “first”, “second”, “third”, and “fourth” (if any) in the description and claims of the present disclosure and in the accompanying drawings are used for distinguishing between similar objects, and not necessarily used for describing a particular order or successive sequence. The data used in this way are exchangeable in a proper case, so that the embodiments of the present disclosure described herein can be implemented in an order different from those shown or described herein. In addition, the terms “comprise”, “include”, “have”, and their any variants are intended to cover the non-exclusive inclusion. For example, a process, method, system, product, or device that includes a series of steps or units is not necessarily limited to those steps or units expressly listed, but can include other steps or units not expressly listed or inherent to such a process, method, product, or device.

Various embodiments provide a method, apparatus, and device for scheduling an instruction, a storage medium, and a program product. Thus, an instruction search space is expanded, scheduling performance is improved, and a scheduling speed is increased. The present disclosure is applied to at least the fields of artificial intelligence, compilation, etc.

With its research and progress, the artificial intelligence technology has been studied and applied in various fields, such as common smart home, smart wearable devices, virtual assistants, smart speakers, unmanned driving, automatic driving, unmanned aerial vehicles, robots, smart healthcare, and smart customer service. It is believed that with the technical development, the artificial intelligence technology will be applied to an increasing number of fields and plays an increasingly important role. The artificial intelligence is a type of theory, method, technology, and application system that simulates, extends, and expands human intelligence, perceives an environment, acquires knowledge, and obtains an optimal result based on the knowledge through a digital computer or a machine controlled by the digital computer. To be specific, the artificial intelligence, a comprehensive technology in computer science, is attempting to understand the essence of intelligence and produce a novel intelligent machine that can react in a manner similar to that of human intelligence. The artificial intelligence is to research design principles and implementation methods of various intelligent machines, to enable the machines to have functions of perception, inference, and decision-making.

The artificial intelligence technology, a comprehensive discipline, relates to a wide range of fields including hardware-level technologies and software-level technologies. The basic artificial intelligence technology generally involves a sensor, a special-purpose artificial intelligence chip, cloud computation, distributed storage, a big data processing technology, an operation/interaction system, and electromechanical integration. The artificial intelligence software technology mainly includes a computer vision technology, a voice technology, a natural language processing technology, machine learning/deep learning, etc.

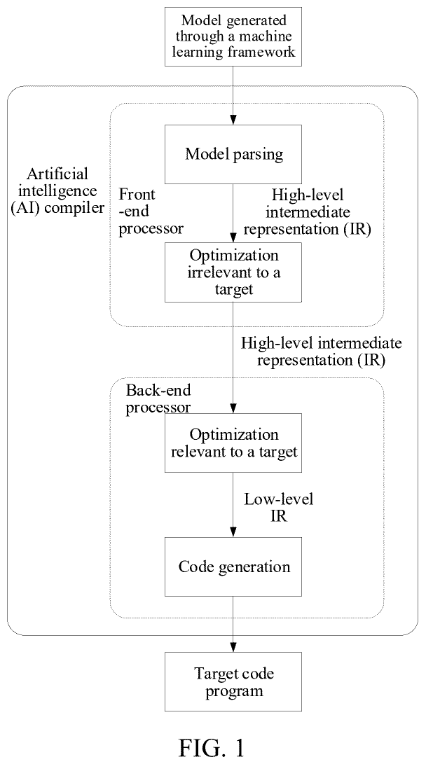

A variety of organizations are engaged in research of relevant artificial intelligence (AI) infrastructures at present. In terms of an AI chip architecture, two principal types of chip architecture solutions are available. One type is to add an AI acceleration function to a conventional chip architecture, and the other type is to employ a special-purpose AI chip. To construct a complete application ecological environment, it is critical to develop and design an AI compiler. The AI compiler is typically formed by a front-end structure and a back-end structure, and connects a model generated through a machine learning framework to an underlying chip, to generate a target code program. FIG. 1 is a schematic diagram of an overall architecture of the AI compiler. As shown in FIG. 1, the AI compiler reads a model generated from a machine learning framework such as TensorFlow and Pytorch. Then, a front-end processor parses the model into a high-level intermediate representation (IR), and performs optimization processing irrelevant to a target hardware structure, such as arithmetic reduction and operator fusion, on the high-level IR, to output an optimized high-level IR. Finally, a back-end processor performs optimization processing relevant to the target hardware structure, such as special-purpose instruction mapping, internal memory assignment, and access and memory delay hiding, on the optimized high-level IR, to output a low-level IR. In this way, the back-end processor performs code generation processing on the low-level IR, and finally generates a target code program runnable on the AI chip.

In a process of back-end code generation of the AI compiler, software pipelining is an important optimization stage. Optimization is performed through a software pipelining optimization algorithm, which is mainly used as an operator of a basic computation unit of an AI model, has a large number of loop instruction structures, and thus consumes more chip execution time. The software pipelining optimization algorithm is a type of compilation algorithm specifically configured for optimizing the loop instruction structure. At present, a modulo scheduling algorithm is a prevalent software pipelining optimization algorithm in the field.

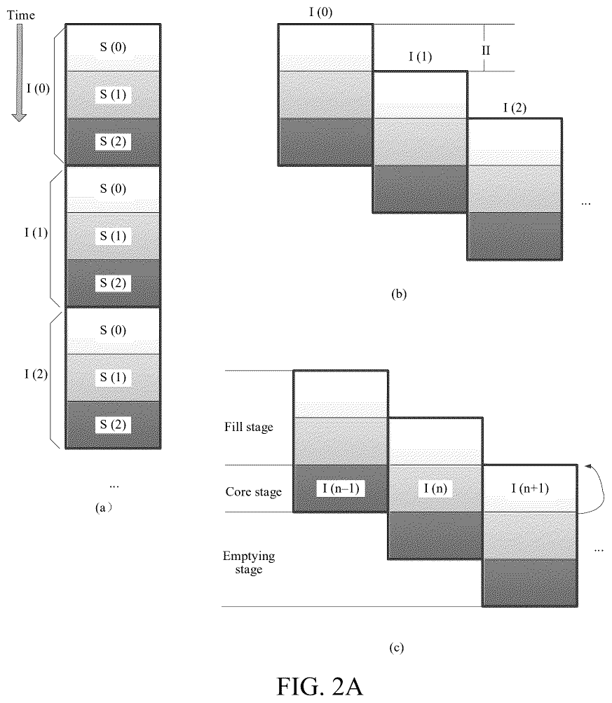

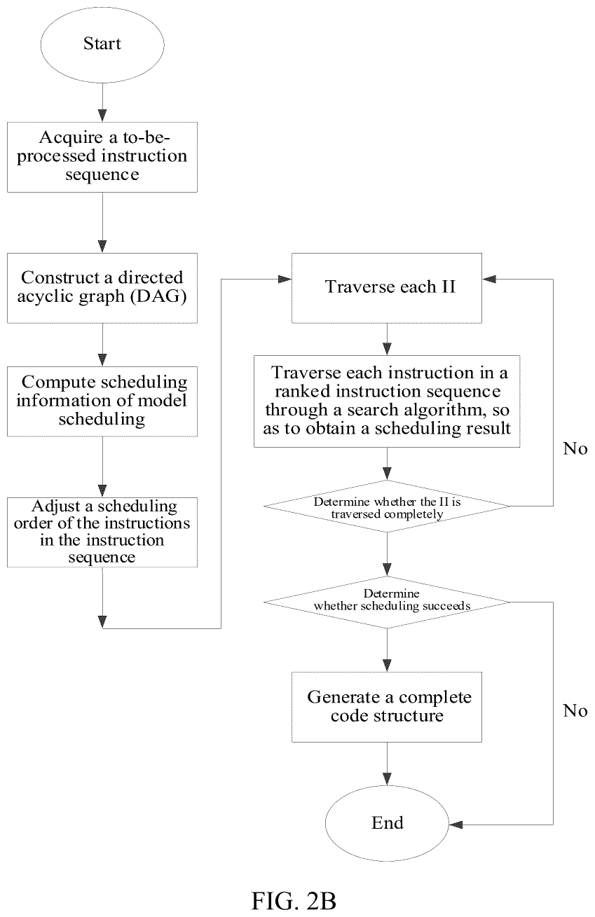

FIG. 2A is a schematic structural diagram of the modulo scheduling algorithm. As shown in FIG. 2A, it is assumed that N denotes a total loop number of one loop. For an instruction sequence in a core loop, T beats are consumed in each loop, where T may be, for example, equally divided into three stages. In a part (a) in FIG. 2A, each loop starts to be executed after a previous loop is executed completely, and is denoted by I (n), where n∈[0, 1, 2, . . . , N−2, and N−1]. For one loop, S (n) denotes each code stage equally divided. The loop is illustratively divided into three stages in the figure. To be specific, n∈[0, 1, and 2]. Codes undergoing model scheduling are shown in a part (b) in FIG. 2A. An instruction of a loop I (n+1) may be pre-executed without waiting for completion of execution of a loop I (n). A difference between execution activation time of I (n) and execution activation time of I (n+1) is generally referred to as an initiation interval (II). In other words, II is equivalent to a number of occupied beats of one code stage in one loop. For example, II=T/3 in FIG. 2A. An initiation interval of every two adjacent instructions in the loop code structure may be acquired through the II. In other words, a number of delayed beats of every two adjacent instructions in the loop code structure may be acquired through the II.

After obtained, the codes undergoing model scheduling may be collapsed, to obtain a loop code structure generated after the codes are collapsed. Reference can be specifically made to a part (c) in FIG. 2A for understanding. As can be seen from the part (c) in FIG. 2A, when a collapsed loop is analyzed, it can be found that a stable code structure, i.e. a code structure after model scheduling, exists. The code structure after model scheduling includes three stages, i.e. a filling stage, a core stage, and an emptying stage. The filling stage mainly includes codes in start portions of first two loops. The core stage mainly includes some codes in three consecutive loops. The emptying stage includes codes in end portions of last two loops.

For a specific instruction in the loop, assuming that in a particular loop, a scheduling moment of the specific instruction is at a K^{th} beat relative to a first instruction in the loop, and T=K Mod II denotes a scheduling moment of the instruction in the core stage after collapsing, which exactly derives the name of model scheduling. Mod denotes modulo processing. For example, if the II is 10 beats, assuming that before collapsing, a scheduling moment of an instruction A is at the sixteenth beat relative to the first instruction in a current loop, it indicates that the instruction A is scheduled at the sixth beat in the collapsed code structure, and an execution time of the core loop is also compressed to 10 beats.

The above scheduling moment or may be referred to as a transmission moment in some scenarios, and is not specifically limited in the embodiments of the present disclosure.

FIG. 2B is a schematic flowchart of a modulo scheduling algorithm. As shown in FIG. 2B, a to-be-processed instruction sequence is first acquired from the front-end processor, and a directed acyclic graph (DAG) is constructed according to the instruction sequence. A dependency relation between the instructions may be indicated through the directed acyclic graph. Also, scheduling information of model scheduling, for example, an initial value and a maximum value of the II, and scheduling-relevant parameters such as a node depth and a node height in the DAG, is computed. After the scheduling information is computed, a scheduling order of the instructions in the instruction sequence is adjusted based on the scheduling information, to obtain a ranked instruction sequence. In this way, each II is traversed starting from an initial value of the II in sequence. Whether scheduling of each instruction in the ranked instruction sequence can succeed is traversed through a search algorithm, until a maximum value of the II is traversed. Specifically, in a process of scheduling through the search algorithm, for a particular II, a scheduling operation is performed on each instruction in the ranked instruction sequence in sequence. Whether scheduling of each instruction at a scheduling moment in a corresponding scheduling time window can succeed is determined based on determination conditions, such as whether resource conflict exists between a current instruction and a scheduled instruction, and whether an irrational dependency relation exists between the instructions. If scheduling of each instruction can succeed, a complete code structure is generated according to a scheduling result. To be specific, the code structure of the part (c) in FIG. 2A is generated, including a filling stage, a core stage, and an emptying stage.

As can be seen from FIG. 2A and FIG. 2B, a key of the modulo scheduling algorithm lies in whether values of the II generated when scheduling of all the instructions in the ranked instruction sequence succeeds can be found rapidly. Reference can be specifically made to the search algorithm in FIG. 2B for understanding.

For the search algorithm mentioned in the modulo scheduling algorithm in FIG. 2B, instruction scheduling processing is generally performed based on a backtracking search algorithm at present. The instruction scheduling may be interpreted as re-ranking an instruction order in a compilation optimization scenario. Thus, an instruction-level parallel operation is improved, and performance of an instruction pipeline on a computer is improved. In a process of scheduling, a core loop is expanded repeatedly. In consequence, a number of instructions in the core loop is continuously multiplied along with an increase in the number of expansion, and an instruction search space is exponentially expanded. For example, assuming that the core loop includes 10 instructions, after the loop is expanded four times, at least 40 instructions are included. However, for the current backtracking search algorithm, backtracking adjustment is focused on an instruction close to a scheduling failure. Consequently, scheduling performance is poor because it is impossible to expand the instruction search space for instruction scheduling processing. Moreover, the current backtracking search algorithm, not a type of parallel algorithm, cannot increase a scheduling speed.

To solve the above technical problems, a method for scheduling an instruction is provided in the embodiments of the present disclosure. Being applied to an AI compiler or a conventional compiler, the method for scheduling an instruction can improve code performance of a core loop generated. Specifically, the method may be applied to a back-end processor of an AI compiler or a conventional compiler. Alternatively, the method is specifically applied to a code generation module in the back-end processor. The AI compiler may be interpreted as a compiler on which an AI chip or an AI function is deployed. The conventional compiler may be interpreted as another compiler on which no AI chip or AI function is deployed.

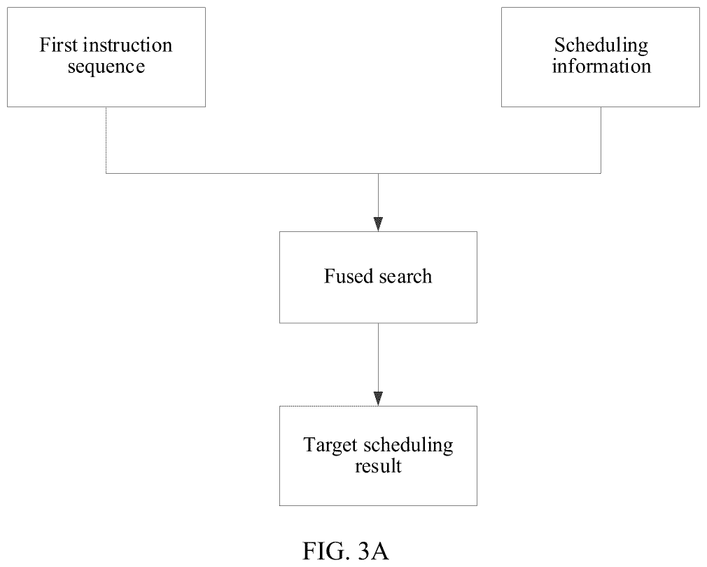

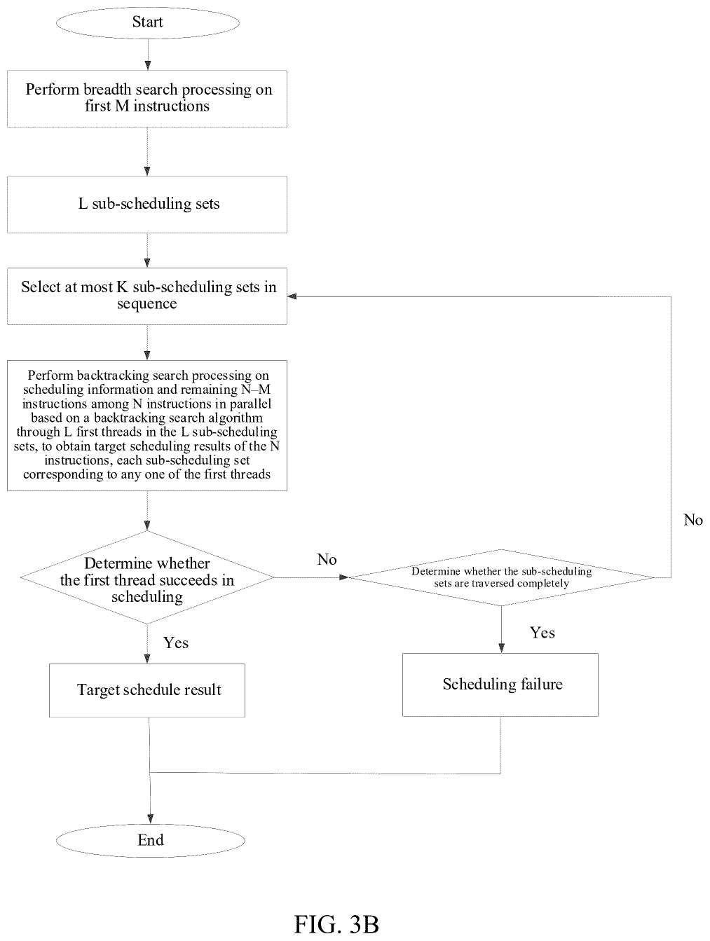

The above method for scheduling an instruction may be applied to a system architecture shown in FIG. 3A according to an embodiment of the present disclosure. As shown in FIG. 3A, in the system architecture, a flow of the search algorithm in FIG. 2B is mainly updated. Illustratively, after a first instruction sequence and scheduling information are acquired, scheduling processing may be performed on the first instruction sequence and the scheduling information based on a fused search solution obtained by combining a breadth search algorithm and a backtracking search algorithm, to obtain a target scheduling result. As an illustrative description, for the fused search solution shown in FIG. 3A, reference can be made to a schematic diagram of a scheduling flow shown in FIG. 3B for understanding.

As shown in FIG. 3B, in the fused search solution, after the first instruction sequence and the scheduling information are acquired, breadth search processing may be first performed on the scheduling information and first M instructions in the first instruction sequence based on the breadth search algorithm, to obtain L sub-scheduling sets including scheduling results of the first M instructions. Then, after the scheduling results of the first M instructions are obtained through breadth search processing, backtracking search processing is performed on the scheduling information and remaining N-M instructions in parallel based on the backtracking search algorithm through L first threads in the L sub-scheduling sets, to obtain target scheduling results of N instructions. To be specific, backtracking search processing is performed on the scheduling information and the remaining N-M instructions in parallel based on the backtracking search algorithm through respective independent first threads in each sub-scheduling set, to obtain a target scheduling result of the first instruction sequence. More specifically, if any first thread succeeds in scheduling the remaining N-M instructions, the search is completed, and the target scheduling result is generated. Otherwise, if no first thread succeeds in scheduling the remaining N-M instructions, whether the L sub-scheduling sets are traversed completely is determined. More specifically, during scheduling of the sub-scheduling sets, at most K sub-scheduling sets or may be selected from the L sub-scheduling sets each time for processing. If the L sub-scheduling sets are traversed completely, a scheduling failure result is generated. Otherwise, K sub-scheduling sets are selected from the remaining L-K sub-scheduling sets for processing. L is a positive integer, 1≤M<N, and N is a positive integer. Also, N denotes a number of instructions in the first instruction sequence.

Compared with a case where search processing is performed on a ranked instruction sequence directly based on the backtracking search algorithm, in the embodiments of the present disclosure, before backtracking search processing, breadth search processing is first performed with reference to the breadth search algorithm. Thus, the instruction search space can be expanded in a case of a limited number of searches, search accuracy of the target scheduling result can be improved, subsequent generation of a correct target code program can be facilitated, and scheduling performance can be improved. Moreover, a multi-thread backtracking search is supported in the embodiments of the present disclosure. Thus, a scheduling search speed is greatly increased, and scheduling search efficiency is significantly improved.

In some examples, the method for scheduling an instruction according to the present disclosure may be applied to a device for scheduling an instruction having a data processing capability. The AI compiler or the conventional compiler is deployed on the device for scheduling an instruction. Also, the device for scheduling an instruction may include, but is not limited to, a terminal device, a server, a question-answering robot, etc. The terminal device may include, but is not limited to, a smart phone, a tablet computer, a notebook computer, a desktop computer, a smart speaker, an in-vehicle device, a smart watch, a smart wearable device, a smart voice interaction device, a smart appliance, an aircraft, etc. The server may be an independent physical server; or a server cluster or a distributed system composed of a plurality of physical servers; or a cloud server that provides basic cloud computation service such as cloud service, a cloud database, cloud computation, a cloud function, cloud storage, network service, cloud communication, middleware service, domain name service, security service, a content delivery network (CDN), big data, and an artificial intelligence platform, which is not specifically limited in the present disclosure. Also, the terminal device and the server may be connected directly or indirectly in a wired communication mode or a wireless communication mode, which is not specifically limited in the present disclosure.

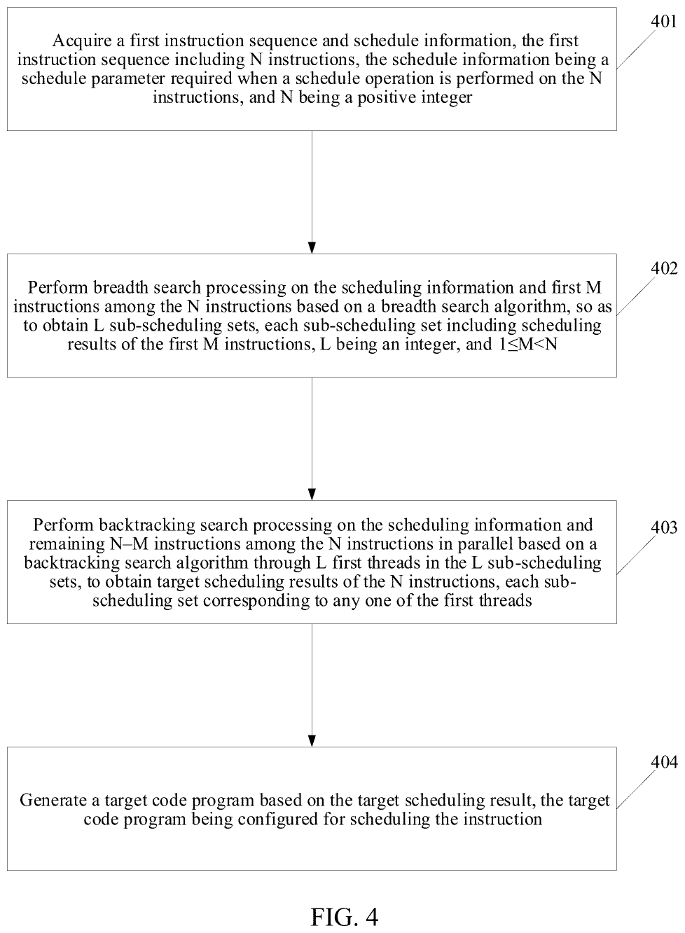

The method for scheduling an instruction according to the embodiments of the present disclosure is described below with reference to the accompanying drawings. FIG. 4 is a flowchart of a method for scheduling an instruction according to an embodiment of the present disclosure. As shown in FIG. 4, the method for scheduling an instruction may include the following operations:

401, acquire a first instruction sequence and scheduling information, the first instruction sequence including N instructions, the scheduling information being a scheduling parameter required when a scheduling operation is performed on the N instructions, and N being a positive integer.

In the example, the first instruction sequence is a sequence obtained after a second instruction sequence transmitted by the front-end processor is re-ranked. The second instruction sequence is interpreted as a sequence without instruction ranking. Illustratively, in a process of generating a code program, the back-end processor may first acquire the second instruction sequence transmitted by the front-end processor, and then re-rank the instructions in the second instruction sequence, to obtain the first instruction sequence. For example, the second instruction sequence may be re-ranked based on a preset swing algorithm or a hypernode reduction model scheduling (HRMS) algorithm, which is not limited in the embodiments of the present disclosure. The first instruction sequence includes the N instructions, N being a positive integer.

Also, in a process of generating the code program, a scheduling parameter, i.e. the scheduling information, required when the scheduling operation is performed on the N instructions needs to be further acquired. Thus, the scheduling information is also required to be acquired in the embodiments of the present disclosure. Illustratively, the scheduling information includes a first weight and an initiation interval. The first weight is configured for indicating a dependency degree of every two adjacent instructions among the N instructions. The initiation interval (i.e. the II mentioned in FIG. 2A) may indicate execution interval time when the scheduling operation is performed on every two adjacent instructions separately. In some other examples, the scheduling information may further include a number of search layers of the breadth search algorithm, a maximum threshold of a number of searches in the backtracking search algorithm, a maximum number of threads, etc., which is not specifically limited in the embodiments of the present disclosure.

The front-end processor may first perform the scheduling operation on the initiation interval in the above scheduling information based on a preset minimum initiation interval, and continuously increase the initiation interval based on the minimum initiation interval. In this way, an initiation interval generated in a case of optimal scheduling performance is transmitted to the back-end processor. Thus, the back-end processor may acquire the initiation interval. Also, the front-end processor may compute the first weight in the scheduling information based on the dependency degree between every two instructions, and then inform the back-end processor of the first weight. Further, the number of search layers of the breadth search algorithm in the scheduling information, the maximum threshold of the number of searches in the backtracking search algorithm, and the maximum number of threads may be determined based on empirical values during search processing, and are not specifically limited in the present disclosure.

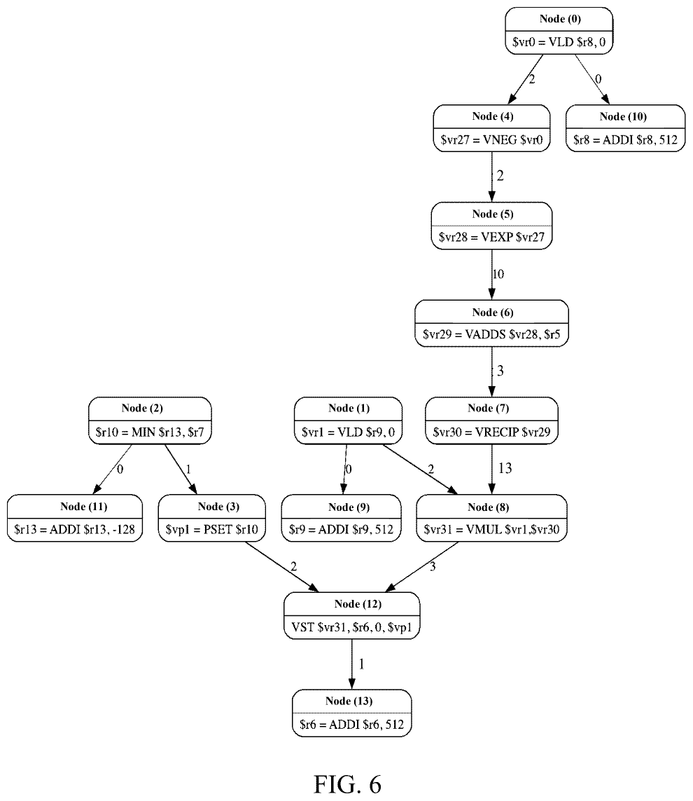

As an illustrative description, in a process of re-ranking the second instruction sequence, a directed acyclic graph may be specifically constructed based on the second instruction sequence. The directed acyclic graph includes N nodes and a directed edge weight between the nodes. The node is configured for indicating an instruction, and the directed edge weight is configured for indicating a number of delayed beats between instructions corresponding to every two nodes respectively. As an illustrative description, a corresponding directed edge weight may be computed based on an output delay of each instruction. For example, with a node (0) and a node (4) in a directed acyclic graph shown in FIG. 6 subsequently as an example, a processor corresponding to the node (0) outputs an instruction “$vr0=VLD $r8, 0”, and a processor corresponding to the node (4) uses and processes the instruction “$vr0=VLD $r8, 0”. In this case, an output delay (i.e. from the node (0) to the node (4)) of the instruction “$vr0=VLD $r8, 0” may be taken as a directed edge weight, for example, 2, between the node (0) and the node (4), which is not specifically limited in the present disclosure. In this way, after the directed acyclic graph is constructed, the second instruction sequence is re-ranked based on the scheduling information and the directed acyclic graph, to obtain the first instruction sequence.

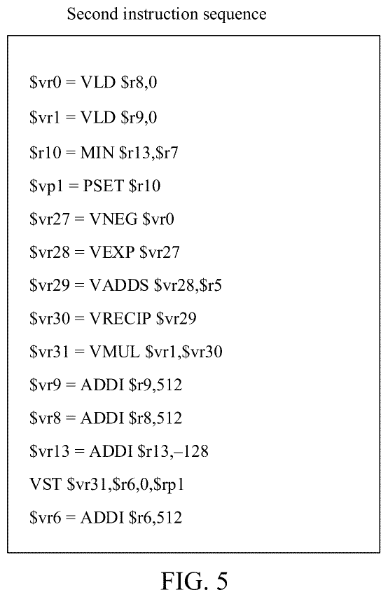

For example, FIG. 5 is a schematic diagram of an unranked instruction sequence according to an embodiment of the present disclosure. As shown in FIG. 5, the second instruction sequence includes 14 instructions, for example, an instruction “$vr0=VLD $r8, 0”, an instruction “$vr1=VLD $r9, 0”, an instruction “$r10=MIN $r12, $r7”, . . . , and “$r6=ADDI $r6, 512”. With the instruction “$vr0=VLD $r8, 0” as an example, it can be seen that data of a register $r8 are outputted to a register $vr0, and VLD denotes an instruction name. Also, the output register $vr0 may be connected to the instruction name VLD through “=”, and the input register $r8 and a constant 0 are placed after the instruction name VLD, and are spaced by “,”. The above constant 0 may be interpreted as that an offset between the constant 0 and an address of $r8 is 0. In an actual application, a value of a specific offset may be determined according to scheduling demand, and is not limited in the present disclosure.

Reference can also be made to the content of the instruction “$vr0=VLD $r8, 0” for understanding other instructions in FIG. 5, for example, the instruction “$vr1=VLD $r9, 0”, and the instruction “$r10=MIN $r12, $r7”, which will not be repeated herein. Also, the instruction name shown in FIG. 5 may also include, but is not limited to, MIN, PSET, ADDI, VMUL, VADDS, VEXP, etc., which is not limited in the embodiments of the present disclosure.

In the second instruction sequence shown in FIG. 5, data may be transferred between the instructions and between the instruction and an internal memory through the register. Thus, the dependency relation between the instructions in the second instruction sequence shown in FIG. 5 is analyzed, to construct the corresponding directed acyclic graph. Reference can be specifically made to the directed acyclic graph shown in FIG. 6 for understanding. As shown in FIG. 6, the second instruction sequence shown in FIG. 5 may be ranked according to a current instruction, to convert the corresponding instructions into nodes respectively. The corresponding instruction may be indicated through the node, and a node sequence number may indicate an input order of the instruction. For example, the node (0) may be configured for denoting a first instruction in the second instruction sequence, i.e. the instruction “$vr0=VLD $r8, 0”; the node (1) is configured for denoting a second instruction in the second instruction sequence, i.e. the instruction “$vr1=VLD $r9, 0”; the node (3) is configured for denoting a third instruction in the second instruction sequence, i.e. the instruction “$r10=MIN $r12, $r7”; . . . ; and the node (13) is configured for denoting a fourteenth instruction in the second instruction sequence, i.e. the instruction “$r6=ADDI $r6, 512”.

Also, a directed edge is set between every two nodes for data transmission. A number of delayed beats (i.e. a number of delayed beats of data transmission) between instructions corresponding to every two corresponding nodes may be indicated through the directed edge weight. For example, assuming that a directed edge weight between the node (0) and the node (4) is 2, after an instruction corresponding to the node (0) is scheduled, scheduling processing can be performed on an instruction (i.e. a fifth instruction in the second instruction sequence) corresponding to the node (4) after at least two beats.

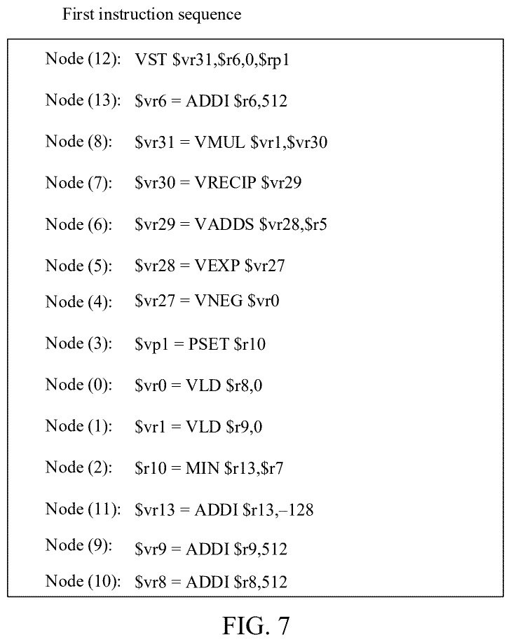

In this way, after the directed acyclic graph shown in FIG. 6 is obtained, the instructions in the second instruction sequence shown in FIG. 5 may be re-ranked through a ranking module, etc. based on the scheduling information and the directed acyclic graph. Thus, instruction scheduling performance can be improved. For example, FIG. 7 is a schematic diagram of a first instruction sequence according to an embodiment of the present disclosure. As shown in FIG. 7, after the second instruction sequence in FIG. 5 is re-ranked, the first instruction sequence obtained also includes 14 instructions, and a successive scheduling order of the 14 instructions is as follows: Node (13)->Node (12)->Node (8)->Node (7)->Node (6)->Node (5)->Node (4)->Node (3)->Node (0)->Node (1)->Node (2)->Node (11)->Node (9)->Node (10). Reference can be made to the content shown in FIG. 5 for understanding the instructions denoted by the node (13), the node (12), etc. respectively, which will not be repeated herein.

402, perform breadth search processing on the scheduling information and first M instructions among the N instructions based on the breadth search algorithm, to obtain L sub-scheduling sets, each sub-scheduling set including scheduling results of the first M instructions, L being an integer, and 1≤M<N.

In the example, since the first instruction sequence is a sequence obtained after re-ranking, after the first instruction sequence is acquired, the first M instructions may be extracted from the first instruction sequence. 1≤M<N. In this way, after the scheduling information is acquired, breadth search processing may be performed on the scheduling information and the first M instructions based on the breadth search algorithm, to obtain the L sub-scheduling sets, L being a positive integer. Each of the L sub-scheduling sets includes scheduling results of the first M instructions, and scheduling results of the first M instructions included in each sub-scheduling set are different.

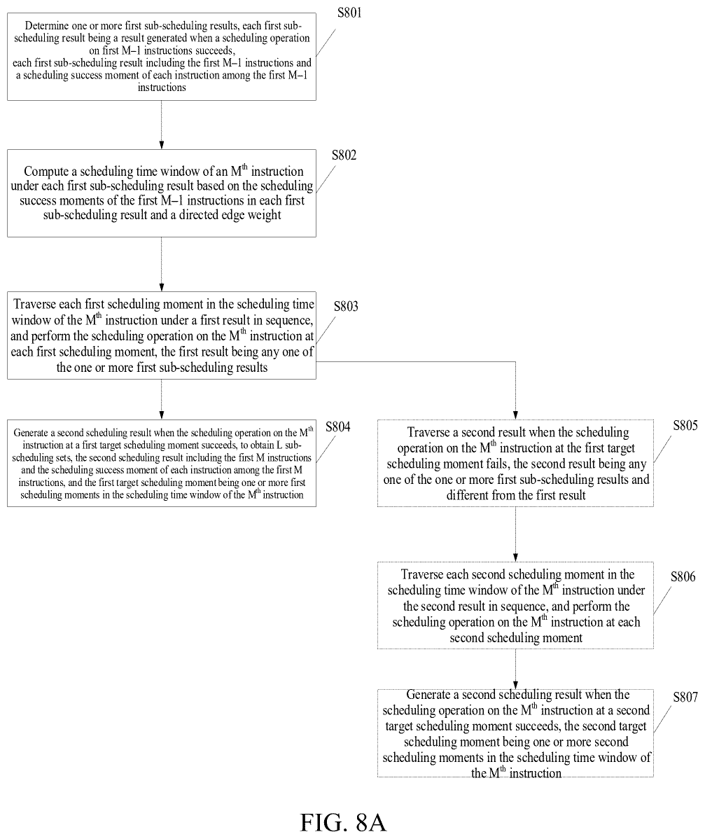

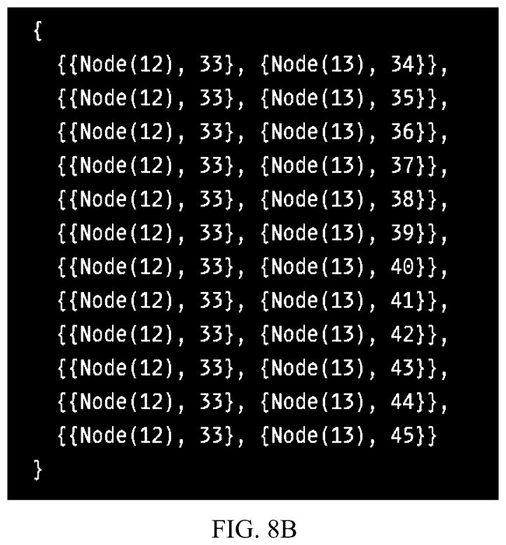

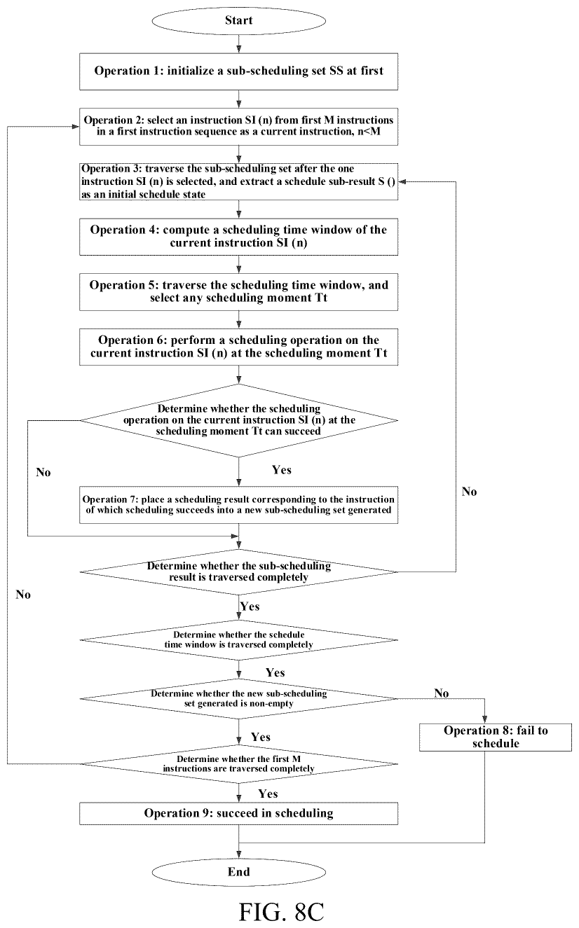

Reference can be to the processing flow shown in FIG. 8A below for understanding the method for obtaining the L sub-scheduling sets through the breadth search. As shown in FIG. 8A, the processing flow of the breadth search includes at least the following operations.

S801, determine one or more first sub-scheduling results, each first sub-scheduling result being a result generated when the scheduling operation on first M-1 instructions succeeds, and each first sub-scheduling result including the first M-1 instructions and a scheduling success moment of each instruction among the first M-1 instructions.

For example, assuming that from the scheduling information, the breadth search algorithm has a number of search layers of 2 and a number of beats of 13 for a particular II, in this case, in a process of performing breadth search processing, the first instruction, i.e. the instruction corresponding to the node (12), ranked at a first position in the first instruction sequence is first extracted. If the scheduling operation on the instruction corresponding to the node (12) at a scheduling moment of the thirty-third beat succeeds, a first sub-scheduling result correspondingly obtained may be {node (12), 33}. In this case, the first sub-scheduling result may be interpreted as a result generated when a scheduling operation on a previous instruction succeeds.

How to determine each first sub-scheduling result is actually to perform breadth search processing on the first M-1 instructions. Thus, reference can be made to processing of performing the breadth search on the first M instructions shown in FIG. 8A for understanding processing of taking a result generated when the scheduling operation succeeds as the first sub-scheduling result, which will not be repeated herein.

S802, compute a scheduling time window of an M^{th} instruction under each first sub-scheduling result based on scheduling success moments of first M-1 instructions in each first sub-scheduling result and the directed edge weight.

In this example, as can be seen from the directed acyclic graph shown in FIG. 6, a previous-level instruction may point to one instruction, and the one instruction may point to a subsequent-level instruction. For example, for an instruction (for example, the node (12)), previous-level instructions include a node (3) and a node (8), and a subsequent-level instruction includes a node (13). A scheduling success moment of the previous-level instruction and a scheduling success moment of the subsequent-level instruction affect a scheduling moment of the current instruction.

Thus, the scheduling time window of the M^{th} instruction may be computed by determining whether the first M-1 instructions include one or more previous-level instructions and one or more subsequent-level instructions. The scheduling time window may be interpreted as a candidate set of transmission time of the instruction. A process of computing the scheduling time window of the M^{th} instruction is specifically as follows:

### (1) The First M-1 Instructions Include a Previous-Level Instruction and a Subsequent-Level Instruction of the M^{th} Instruction

Illustratively, in a case where the first M-1 instructions include the previous-level instruction and the subsequent-level instruction of the M^{th} instruction, one or more first instructions and one or more second instructions are first determined from the first M-1 instructions. Each first instruction points to the M^{th} instruction in the directed acyclic graph, and the M^{th} instruction points to each second instruction in the directed acyclic graph.

For example, it is assumed that an instruction M1 and an instruction M2 among the first M-1 instructions are adjacent to the M^{th} instruction, and the instruction M1 and the instruction M2 point to the M^{th} instruction in the directed acyclic graph. Similarly, it is assumed that an instruction M3 and an instruction M4 among the first M-1 instructions are also adjacent to the M^{th} instruction, and the M^{th} instruction points to the instruction M3 and the instruction M4 in the directed acyclic graph.

Then, a first value is determined based on a scheduling success moment of the one or more first instructions and the first directed edge weight. The first directed edge weight is a directed edge weight between each first instruction and the M^{th} instruction. Illustratively, to ensure that when the M^{th} instruction is scheduled, scheduling of the previous-level instructions belonging to the M^{th} instruction among the first M-1 instructions has succeeded, in a process of computing the above first value, the scheduling success moment of each first instruction and a corresponding first directed edge weight may be summed to obtain at least one first moment through computation. Further, a maximum moment is selected from the at least one first moment as the first value.

For example, if the instruction M1 and the instruction M2 point to the M^{th} instruction, t1 and t2 denote scheduling success moments of the instruction MI and the instruction M2 respectively. Also, when W1 denotes a first directed edge weight between the instruction M1 and the M^{th} instruction, and W2 denotes a first directed edge weight between the instruction M2 and the M^{th} instruction, the scheduling success moment of the instruction M1 and the corresponding first directed edge weight is summed, and the scheduling success moment of the instruction M2 and the corresponding first directed edge weight is summed, to obtain two first moments through computation. To be specific, T1=t1+W1, and T2=t2+W2. After comparison, the maximum moment may be selected from T1 and T2 as the first value.

Similarly, a second value is determined based on a scheduling success moment of the one or more second instructions and a second directed edge weight. The second directed edge weight is a directed edge weight between each second instruction and the M^{th} instruction, and the second value is greater than the first value. For example, to ensure that when the M^{th} instruction is scheduled, scheduling of subsequent-level instructions belonging to the M^{th} instruction among the first M-1 instructions has succeeded, in a process of computing the above second value, a difference value between the scheduling success moment of each first instruction and a corresponding second directed edge weight may be computed to obtain at least one second moment through computation. Further, a minimum moment is selected from the at least one second moment as the second value.

For example, if the M^{th} instruction points to the instruction M3 and the instruction M4, t3 and t4 denote scheduling success moments of the instruction M3 and the instruction M4 respectively. Also, in a case where W3 denotes the second directed edge weight between the instruction M3 and the M^{th} instruction, and W4 denotes the second directed edge weight between the instruction M4 and the M^{th} instruction, the corresponding second directed edge weight is subtracted from the scheduling success moment of the instruction M3, and the corresponding second directed edge weight is subtracted from the scheduling success moment of the instruction M4, to obtain two second moments through computation. To be specific, T3=t1−W1, and T4=t2−W2. After comparison, the minimum moment may be selected from T3 and T4 as the second value.

Finally, the first value and the second value are taken as an initial value and an end value of the scheduling time window of the M^{th} instruction under the first result, to obtain the scheduling time window of the M^{th} instruction under the first result.

Only the instruction M1 and the instruction M2 being as the previous-level instructions of the M^{th} instruction, and the instruction M3 and the instruction M4 being the subsequent-level instructions of the M^{th} instruction are described as an example. In an actual application, the previous-level instructions and the subsequent-level instruction or may be other instructions, which is not specifically limited in the embodiments of the present disclosure.

When the first M-1 instructions include the previous-level instruction and the subsequent-level instruction of the M^{th} instruction, a possible upper limit and a possible lower limit of scheduling time of the M^{th} instruction can be rapidly and accurately determined based on a scheduling order of the directed graph through relevant information of a context instruction of the M^{th} instruction. Thus, the scheduling time window can be determined.

### (2) The First M-1 Instructions Include the Previous-Level Instruction Rather Than the Subsequent-Level Instruction of the M^{th} Instruction

Illustratively, in a case where the first M-1 instructions only include the previous-level instruction rather than the subsequent-level instruction of the M^{th} instruction, one or more first instructions are first determined from the first M-1 instructions, and a first value is determined based on a scheduling success moment of the one or more first instructions and a first directed edge weight. Reference can be made to the content in the above (1) for understanding the first instruction and the first directed edge weight mentioned herein. Also, reference can be made to the content in the above (1) for understanding a process of computing the first value herein, which will not be repeated herein.

After the first value is computed, the first value and the initiation interval are summed to obtain a third value. In this way, the first value and the third value are taken as an initial value and an end value of the scheduling time window of the M^{th} instruction under the first result, to obtain a scheduling time window of the M^{th} instruction under the first result.

For example, with the instance shown in the above mode (1) as an example, in a case where from T1=t1+W1 and T2=t2+W2, it is determined that T2 denotes a maximum moment, and to be specific, T2 denotes the first value, the third value is equal to the sum of the first value and the initiation interval, i.e. T*=T2+II=t2+W2+II. In this case, the scheduling time window of the M^{th} instruction is [t2+W2, t2+W2+II].

Alternatively, with the first result being the first sub-scheduling result (i.e. {node (12), 33}), and M=2 as an example, it can be acquired from {node (12), 33} that the scheduling success moment of the first instruction is at the thirty-third beat. Moreover, it is assumed that from the scheduling information, II is equal to 13 beats, and to be specific, the initiation interval is 13 beats. Also, as can be seen from FIG. 6, a directed edge weight between the second instruction (i.e. the node (13)) in the first instruction sequence and the first instruction (i.e. the node (12)) in the first instruction sequence is 1, which indicates that the scheduling operation on the second instruction needs to be delayed by at least 1 beat with respect to the first instruction. In this case, the directed edge weight and the scheduling success moment of the first instruction are summed to obtain 34 beats as the third value. To be specific, the thirty-forth beat is taken as the initial value of the scheduling time window of the second instruction. Moreover, the sum (i.e. 46 beats) of the scheduling success moment of the first instruction and the initiation interval is taken as a fourth value. To be specific, the forty-sixth beat is taken as the end value of the scheduling time window of the second instruction. Based on the above, the scheduling time window of the second instruction under the first result is constructed as [34, 46].

### (3) The First M-1 Instructions Include the Subsequent-Level Instruction Rather Than the Previous-Level Instruction of the M^{th} Instruction

Illustratively, in a case where the first M-1 instructions only include the subsequent-level instruction rather than the previous-level instruction of the M^{th} instruction, one or more second instructions are first determined from the first M-1 instructions, and a second value is determined based on scheduling success moment of the one or more second instructions and a second directed edge weight. Reference can be made to the content in the above (1) for understanding the second instruction and the second directed edge weight mentioned herein. Also, reference can be made to the content in the above (1) for understanding a process of computing the second value herein, which will not be repeated herein.

After the second value is computed, a difference value between the second value and the initiation interval is computed to obtain a fourth value. In this way, the fourth value and the second value are then taken as an initial value and an end value of a scheduling time window of the M^{th} instruction under the first result, to obtain the scheduling time window of the M^{th} instruction under the first result.

For example, with the instance shown in the above mode (1) as an example, in a case where from the second moment T3=t3+W3 and T4=t4+W4, it is determined that T4 denotes a minimum moment, and to be specific, T4 denotes the second value, the fourth value is equal to a difference between the second value and the initiation interval, i.e. T**=T4−II=t4−W4−II. In this case, the scheduling time window of the M^{th} instruction is [t4−W4−II, t4−W4].

### (4) The First M-1 Instructions Include Neither the Subsequent-Level Instruction nor the Previous-Level Instruction of the M^{th} Instruction

Illustratively, in a case where the first M-1 instructions neither include the subsequent-level instruction nor the previous-level instruction of the M^{th} instruction, a scheduling moment 0 may be taken as an initial value of a scheduling time window of the M^{th} instruction. In addition, the sum of the initial value and the initiation interval is taken as an end value of the scheduling time window of the M^{th} instruction. In this case, the scheduling time window of the M^{th} instruction is [0, II].

S803, traverse each first scheduling moment in the scheduling time window of the M^{th} instruction under the first result in sequence, and perform the scheduling operation on the M^{th} instruction at each first scheduling moment, the first result being any one of the one or more first sub-scheduling results.

S804, generate a second scheduling result when the scheduling operation on the M^{th} instruction at a first target scheduling moment succeeds, to obtain L sub-scheduling sets, the second scheduling result including the first M instructions and a scheduling success moment of each instruction among the first M instructions, and the first target scheduling moment being one or more first scheduling moments in the scheduling time window of the M^{th} instruction.

Illustratively, whether the scheduling operation can succeed may be determined by determining whether the scheduling operation on another instruction among the M instructions at the first target scheduling moment has succeeded. In a case where no scheduling operation on another instruction among the M instructions at the first target scheduling moment succeeds, scheduling of the M^{th} instruction at the corresponding first target scheduling moment may succeed. On the contrary, in a case where the scheduling operation on another instruction among the M instructions at the first target scheduling moment has succeeded, no scheduling of the M^{th} instruction at the corresponding first target scheduling moment can succeed. In a case where the scheduling operation on the instruction succeeds, there is no resource conflict, no dependency relation conflict, etc. between the instructions, which is not specifically limited in the embodiments of the present disclosure.

For example, with a scheduling time window of the second instruction under the first result being [34, 46] as an example, in the scheduling time window [34, 46], whether the scheduling operation on the second instruction at each first scheduling moment in the scheduling time window [34, 46] can succeed needs to be traversed in sequence. A corresponding scheduling result is generated when the scheduling operation succeeds. For example, since the number M of search layers of the breadth search algorithm is equal to 2, each sub-scheduling set includes scheduling results of two instructions. For example, when the first scheduling moment is at the thirty-fourth beat, the scheduling operation is performed on the second instruction at the thirty-fourth beat. If the attempt to perform the scheduling operation on the second instruction at the thirty-fourth beat can succeed, a corresponding second scheduling result {{node (12), 33}, {node (13), 34}} is generated. Similarly, when the first scheduling moment is at the thirty-fifth beat, the scheduling operation is performed on the second instruction at the thirty-fifth beat. If the attempt to perform the scheduling operation on the second instruction at the thirty-fifth beat can succeed, a corresponding second scheduling result {{node (12), 33}, {node (13), 35}} is generated. The rest can be deduced by analogy until the case where the first scheduling moment is the forty-fifth beat is traversed. If the scheduling operation on the second instruction can still succeed from the thirty-sixth beat to the forty-fifth beat, corresponding second scheduling results {{node (12), 33}, {node (13), 36}}, and {{node (12), 33}, and {node (13), 45}} are generated.

Similarly, when the first scheduling moment is at the forty-sixth beat, the scheduling operation is performed on the second instruction at the forty-sixth beat. If no attempt to perform the scheduling operation on the second instruction at the forty-sixth beat can succeed, no corresponding second scheduling result can be generated.

In this way, breadth search processing is performed on the above first two instructions (i.e. the first instruction and the second instruction). Each second scheduling result obtained is integrated to obtain corresponding 12 sub-scheduling sets. Reference can be specifically made to the content shown in FIG. 8B for understanding the above operation, which will not be repeated herein.

Breadth search processing may be performed on the first M instructions in the above mode. Thus, an instruction search space can be expanded in a case of a limited number of searches, and scheduling performance can be improved.

In some embodiments, after the scheduling operation is performed on the M^{th} instruction at each first scheduling moment, a processing flow of the breadth search may further include the following operation S805 to operation S807 as follows:

S805, traverse a second result when the scheduling operation on the M^{th} instruction at the first target scheduling moment fails, the second result being any one of the one or more first sub-scheduling results and different from the first result.

For example, when M=3, if the scheduling operation is performed on the first M-1 instructions (for example, the above node (12) and node (13)), two first sub-scheduling results, i.e. {{node (12), 33}, {node (13), 36}}, and {{node (12), 33}, {node (13), 45}} are generated. Assuming that a scheduling time window of a third instruction is [20, 30], and the first result is {{node (12), 33}, {node (13), 36}}, if scheduling on the third instruction fails by traversing each scheduling moment in the window [20, 30] under the first result in sequence, the second result, i.e. {{node (12), 33}, {node (13), 45}} needs to be traversed.

S806, traverse each second scheduling moment in the scheduling time window of the M^{th} instruction under a second result in sequence, and perform the scheduling operation on the M^{th} instruction at each second scheduling moment.

S807, generate a second scheduling result when the scheduling operation on the M^{th} instruction at a second target scheduling moment succeeds, the second target scheduling moment being one or more second scheduling moments in the scheduling time window of the M^{th} instruction.

Reference can be specifically made to the content described in operation S803 to operation S804 for understanding operation S806 to operation S807, which will not be repeated herein.

As an illustrative description, FIG. 8C is a schematic diagram of another processing flow of the breadth search. As shown in FIG. 8C, the flow includes at least operations 1 to 9. Illustratively, after the first instruction sequence is acquired, operation (1) may be performed. To be specific, a sub-scheduling set SS is first initialized. In this case, there is only one empty sub-scheduling set S_{Φ} in the sub-scheduling set obtained after initialization. Then, operation (2) is performed. To be specific, an instruction SI (n) is selected from the first M instructions in the first instruction sequence as a current instruction, n<M. After the one instruction SI (n) is selected, operation (3) is performed. To be specific, the sub-scheduling set is traversed, and a sub-scheduling result S ( ) is extracted as an initial scheduling state. Next, operation (4) is performed. To be specific, a scheduling time window of the current instruction SI (n) is computed. Reference can be specifically made to the content described in operation S802 in FIG. 8A for understanding the above operation, which will not be repeated herein. After the scheduling time window of the current instruction SI (n) is computed, operation (5) is performed. To be specific, the scheduling time window is traversed, and any scheduling moment (for example, Tₜ) is selected. Next, operation (6) is performed. To be specific, the scheduling operation is performed on the current instruction SI (n) at the scheduling moment Tₜ selected. Specifically, in operation (6), it is determined whether the scheduling operation on the current instruction SI (n) at the scheduling moment Tₜ under the sub-scheduling result S ( ) selected in operation (3) can succeed. If the scheduling succeeds, subsequent operation (7) is entered. Otherwise, if no scheduling of the current instruction SI (n) can succeed, a next sub-scheduling result continues to be traversed, and operation (3) is re-entered. Illustratively, if all sub-scheduling results are traversed in this case, a next scheduling moment (i.e. Tₜ₊₁) is selected for performing the scheduling operation on the current instruction SI (n), and operation (4) is entered. If all scheduling moments in the scheduling time window have been traversed, but no scheduling on the current instruction SI (n) at any scheduling moment can succeed in this case, an empty sub-scheduling set is generated, and subsequent operation (8) is entered. On the contrary, the sub-scheduling set is updated, a next instruction (i.e. SI (n+1)) is selected, and operation (2) is entered, to implement scheduling processing on the next instruction (i.e. SI (n+1)). Reference can be specifically made to a scheduling process of the above instruction (i.e. SI (1)) for understanding the above operation, which will not be repeated herein. Illustratively, if the first M instructions in the first instruction sequence have been traversed completely, and the sub-scheduling set generated is non-empty (to be specific, scheduling of a corresponding instruction at a particular scheduling moment can succeed), subsequent operation (9) is entered.

In the above operation (7), specifically the scheduling result corresponding to the instruction of which scheduling succeeds is placed into the sub-scheduling set newly generated. In the above operation (8), specifically the search is completed and the scheduling fails. In the above operation (9), specifically, the search is completed, scheduling of the instruction succeeds, and a scheduling success result corresponding to the instruction is saved in the sub-scheduling set SS.

When the scheduling operation on the M^{th} instruction at the first target scheduling moment fails, a second target scheduling moment at which the scheduling operation on the M^{th} instruction can succeed is determined by traversing other sub-scheduling results. Stability and efficiency of breadth search processing are improved in such a flexible processing mode.

Reference can be specifically made to the content described in FIG. 8A for understanding the content of determining whether the scheduling operation succeeds mentioned in FIG. 8C, which will not be repeated herein.

403, perform backtracking search processing on the scheduling information and remaining N-M instructions among the N instructions in parallel based on a backtracking search algorithm through L first threads in the L sub-scheduling sets, to obtain target scheduling results of the N instructions, each sub-scheduling set corresponding to any one of the first threads.

In the example, for the remaining N-M instructions among the N instructions, after the breadth search is performed on the first M instructions, backtracking search processing may be performed based on search results of the first M instructions. To improve efficiency and increase a speed of search processing, parallel processing may be performed on the L sub-scheduling sets obtained in operation 403 through L first threads. Illustratively, backtracking search processing is performed on the scheduling information and the remaining N-M instructions among the N instructions based on a backtracking search algorithm through the first thread in each sub-scheduling set, to obtain target scheduling results of the N instructions.

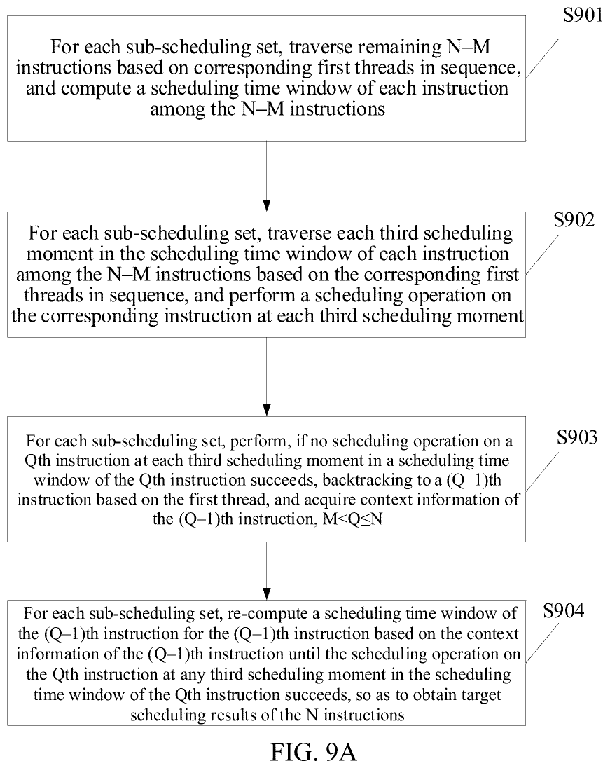

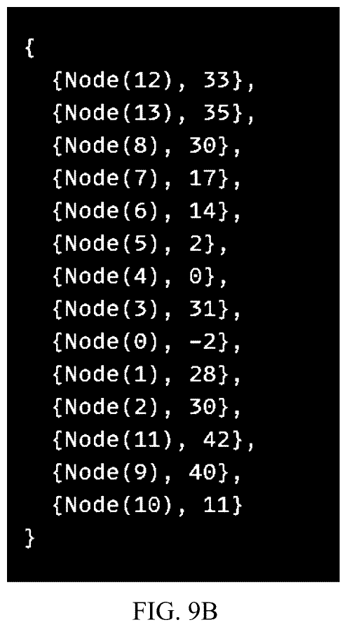

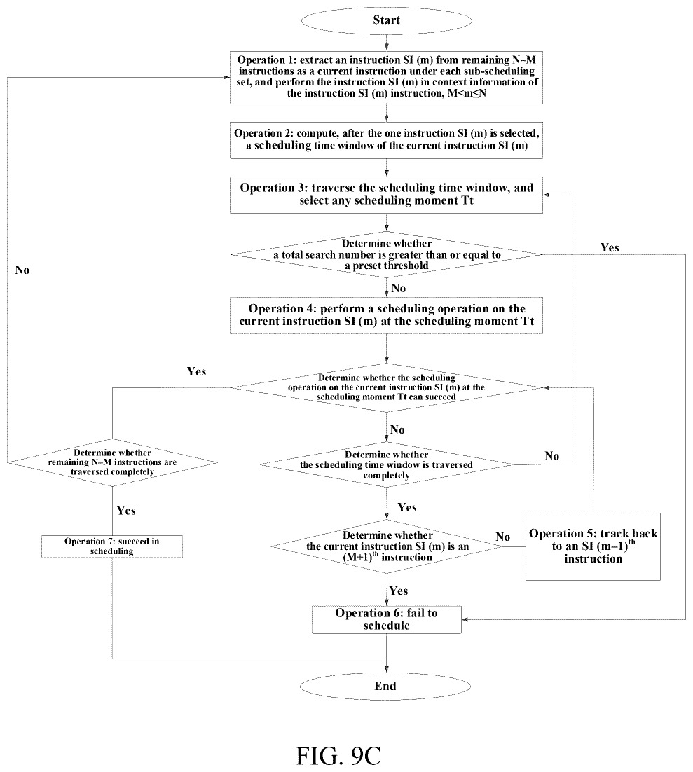

Reference can be made to a processing flow shown in FIG. 9A below for the method for performing a backtracking search on the remaining N-M instructions. As shown in FIG. 9A, the processing flow of the backtracking search includes at least the following operations:

S901, for each sub-scheduling set, traverse the remaining N-M instructions based on corresponding first threads in sequence, and compute a scheduling time window of each instruction among the N-M instructions.

For example, as can be seen from the content shown in FIG. 8B, when breadth search processing is performed on the first two instructions, 12 sub-scheduling sets obtained are {{node (12), 33}, {node (13), 36}}, . . . , and {{node (12), 33}, {node (13), 45}}. For the sub-scheduling set {{node (12), 33}, {node (13), 36}} among the 12 sub-scheduling sets, the remaining N-M=14−2=10 instructions may be traversed through the first thread, and a scheduling time window of each instruction among the remaining 10 instructions under the sub-scheduling set {{node (12), 33}, {node (13), 36}} is computed. The rest can be deduced by analogy. The remaining 10 instructions may be traversed through the twelfth thread for the sub-scheduling set {{node (12), 33}, {node (13), 45}} among the 12 sub-scheduling sets, and a scheduling time window of each instruction among the remaining 10 instructions under the sub-scheduling set {{node (12), 33}, {node (13), 45}} is computed.

Reference can be made to the content mentioned in operation S802 in FIG. 8A for understanding the way to compute the scheduling time window of each instruction, which will not be repeated herein. Also, each of the first thread to the twelfth thread is independent of one another.

S902, for each sub-scheduling set, traverse each third scheduling moment in the scheduling time window of each instruction among the N-M instructions based on the corresponding first threads in sequence, and perform the scheduling operation on the corresponding instruction at each third scheduling moment.

S903, for each sub-scheduling set, perform, if no scheduling operation on a Q^{th} instruction at each third scheduling moment in a scheduling time window of the Q^{th} instruction succeeds, backtracking to a (Q-1)^{th} instruction based on the first thread, and acquire context information of the (Q-1)^{th} instruction, M<Q≤N.

S904, for each sub-scheduling set, re-compute a scheduling time window of the (Q-1)^{th} instruction for the (Q-1)^{th} instruction based on the context information of the (Q-1)^{th} instruction until the scheduling operation on the Q^{th} instruction at any third scheduling moment in the scheduling time window of the Q^{th} instruction succeeds, to obtain the target scheduling results of the N instructions.

For example, with the sub-scheduling set {{node (12), 33}, {node (13), 34}} as an example, each third scheduling moment in the scheduling time windows of the remaining 10 instructions is traversed through the first thread in sequence, and the scheduling operation is performed on the corresponding instruction at each third scheduling moment. For example, search processing continues to be performed on the third instruction (i.e. the node (8)) in the first instruction sequence through the first thread. If it is computed that the scheduling time window of the third instruction is [20, 30], the first thread needs to traverse and determine whether the scheduling operation on the third instruction at each third scheduling moment (i.e. the twentieth beat, the twenty-first beat, etc.) can succeed in sequence. After traversing, if it is obtained that the scheduling operation on the third instruction at the thirtieth beat can succeed, the thirtieth beat is recorded as a scheduling success moment at which scheduling of the third instruction succeeds.

Then, search processing continues to be performed on a fourth instruction (i.e. the node (7)) in the first instruction sequence according to same search processing as that for the third instruction. Search processing continues to be performed on the fourth instruction (i.e. the node (7)) through the first thread. If it is computed that a scheduling time window of the fourth instruction is [17, 17], the first thread needs to traverse and determine whether the scheduling operation on the fourth instruction at each third scheduling moment (i.e. the seventeenth beat, etc.) can succeed in sequence. After traversing, if it is obtained that the scheduling operation on the fourth instruction at the seventeenth beat can succeed, the seventeenth beat is recorded as a scheduling success moment at which scheduling of the fourth instruction succeeds.

A fifth instruction (i.e. the node (6)), a sixth instruction (i.e. the node (5)), . . . , and the twelfth instruction (i.e. the node (11)) in the first instruction sequence continue to be searched through the first thread according to same search processing as that for the third instruction. Scheduling success moments of the corresponding instructions succeed in being computed as follows: the fourteenth beat, the second beat, the zeroth beat, the thirty-first beat, the negative second beat, the twenty-eighth beat, the thirtieth beat, and the forty-second beat.

The above operation is continued until search processing is performed on the thirteenth instruction (i.e. the node (9)) in the first instruction sequence through the first thread according to same search processing as that for the third instruction. If it is computed that the scheduling time window of the thirteenth instruction is [29, 41], the first thread needs to traverse and determine whether the scheduling operation on the thirteenth instruction at each third scheduling moment (i.e. the twenty-ninth beat, the thirtieth beat, etc.) can succeed in sequence. After traversing, if it is obtained that the scheduling operation on the thirteenth instruction at the fortieth beat can succeed, the fortieth beat is recorded as a scheduling success moment at which scheduling of the thirteenth instruction succeeds.

A fourteenth instruction (i.e. the node (10)) continues to be searched. If it is computed that a scheduling time window of the fourteenth instruction is [−1, 11], the first thread needs to traverse and determine whether the scheduling operation on the fourteenth instruction at each third scheduling moment (i.e. the negative first beat, the zeroth beat, the first beat, etc.) can succeed in sequence. In a case where no scheduling operation on the fourteenth instruction at each third scheduling moment in the scheduling time window [−1, 11] can succeed, the first thread needs to trace back to a previous instruction (i.e. the thirteenth instruction), and acquire context information of the thirteenth instruction.

Then, after the context information of the thirteenth instruction is traced back and acquired, a scheduling time window of the thirteenth instruction may be re-computed according to the context information of the thirteenth instruction. For example, in a case where the first thread re-computes and re-determines that the scheduling operation on the thirteenth instruction at the thirty-ninth beat can also succeed, after scheduling of the thirteenth instruction at the thirty-ninth beat succeeds, search processing continues to be re-performed on the fourteenth instruction according to a same principle, until the scheduling operation on the fourteenth instruction at any third scheduling moment (for example, the eleventh beat) in the scheduling time window of the fourteenth instruction succeeds. Thus, target scheduling results of the 14 instructions are obtained. Reference can be specifically made to a schematic diagram of a target scheduling result shown in FIG. 9B for understanding.

Only search processing being performed on the sub-scheduling set {{node (12), 33}, {node (13), 34}} through the first thread is described above as an example. Reference can also be made to the process in which the first thread performs search processing on the sub-scheduling set {{node (12), 33}, {node (13), 34}} for understanding a process in which the second thread performs search processing on the sub-scheduling sets {{node (12), 33}, {node (13), 35}} . . . , and a process in which the twelfth thread performs search processing on the sub-scheduling set {{node (12), 33}, {node (13), 45}}, which will not be repeated herein.

In some exemplary examples, in each scheduling process, every K sub-scheduling set among the L sub-scheduling sets may be first scheduled through K first threads. Then, if no corresponding target scheduling result is generated after the K sub-scheduling sets are scheduled completely, K sub-scheduling sets among remaining L-K sub-scheduling sets continue to be scheduled through the K first threads, and so on, until the corresponding target scheduling result is generated, or the L sub-scheduling sets are traversed completely. The search speed can be increased, and search performance can be improved in the above mode. 1≤K≤L, and K is an integer.

In some exemplary examples, search processing is performed on the corresponding sub-scheduling sets through the independent threads separately. To improve the search performance and increase the search speed, in a process of obtaining the target scheduling results of the N instructions through the search, if the second thread succeeds in performing the scheduling operation on the remaining N-M instructions under the corresponding sub-scheduling set, the scheduling results of the second thread under the corresponding sub-scheduling sets are taken as the target scheduling results of the N instructions, and the third thread stops performing the scheduling operation on the remaining N-M instructions. The second thread is a thread that succeeds in performing the scheduling operation on the remaining N-M instructions in the first thread, and the third thread is another thread in the first thread other than the second thread.

For example, in a case where the first thread can succeed in scheduling the remaining 10 instructions in the sub-scheduling set {{node (12), 33}, {node (13), 34}}, the scheduling result obtained by the first thread under the {{node (12), 33}, {node (13), 34}} is directly taken as the target scheduling results of the 14 instructions. Moreover, other threads (for example, the second thread to the twelfth thread) stop performing search processing on the remaining 10 instructions under the corresponding sub-scheduling set.

In some other exemplary examples, the method for scheduling an instruction may further include the following operation: a first total scheduling number is acquired. It is determined, when the first total scheduling number is greater than or equal to a preset threshold, that no corresponding first thread succeeds in performing the scheduling operation on the remaining N-M instructions. In this case, the target scheduling result obtained by the corresponding first thread under the first sub-scheduling set is a failure result.

The first total scheduling number is a total scheduling number by which the corresponding first thread performs the scheduling operation on the remaining N-M instructions in the first sub-scheduling set. The first sub-scheduling set is any one of the L sub-scheduling sets.

As an illustrative description, FIG. 9C is a schematic diagram of a processing flow of a backtracking search. As shown in FIG. 9C, the method includes operation 1 to operation 7. Illustratively, after L sub-scheduling sets are acquired, operation (1) may be first performed under each sub-scheduling set. To be specific, an instruction SI (m) is extracted from remaining N-M instructions as a current instruction, and performed in context information of the instruction SI (m) instruction, M<m≤N. After one instruction SI (m) is selected, operation (2) is performed. To be specific, a scheduling time window of the current instruction SI (m) is computed. Reference can be specifically made to the content described in operation S802 in FIG. 8A for understanding the above operation, which will not be repeated herein. After the scheduling time window of the current instruction SI (m) is computed, operation (3) is performed. To be specific, the scheduling time window is traversed, and any scheduling moment (for example, Tₜ) is selected. If a total search number is greater than or equal to a preset threshold, subsequent operation (6) is entered. If a total search number is less than a preset threshold, subsequent operation (4) is entered. Then, operation (4) is performed. Specifically, in operation (4), perform the scheduling operation on the current instruction SI (m) at the scheduling moment Tₜ under each sub-scheduling set, and determine whether the scheduling operation on the current instruction SI (m) at the scheduling moment Tₜ can succeed. If the scheduling succeeds, and the remaining N-M instructions are traversed completely, subsequent operation (7) is entered. Otherwise, if the remaining N-M instructions are not traversed completely, operation (1) is entered to select a next instruction as a current instruction. If the scheduling fails, a next scheduling moment (i.e. Tt+1) is selected to perform the scheduling operation on the current instruction SI (M), and operation (3) is entered. If all scheduling moments in the scheduling time window are traversed completely, and the current instruction SI (M) is not an (M+1)^{th} instruction, a previous instruction (i.e. an instruction SI (m−1)) is traced back, and subsequent operation (5) is entered. Otherwise, if all scheduling moments in the scheduling time window are traversed completely, and the current instruction SI (M) is an (M+1)^{th} instruction, subsequent operation (6) is entered.

In the above operation (5), specifically the M^{th} instruction is traced back, and operation (2) to operation (4) are re-performed on the M^{th} instruction. In the above operation (6), specifically the search is completed, and the scheduling fails. In the above operation (7), specifically the search is completed, and scheduling of the instruction succeeds.

Reference can be specifically made to the content described in FIG. 8A for understanding the content of determining whether the scheduling operation succeeds mentioned in FIG. 9C, which will not be repeated herein.

404, generate a target code program based on the target scheduling result, the target code program being configured for scheduling the instruction.

In the example, after the target scheduling result is obtained in the above operation 403, the target code program may be generated based on the target scheduling result. The N instructions may be scheduled through the target code program.

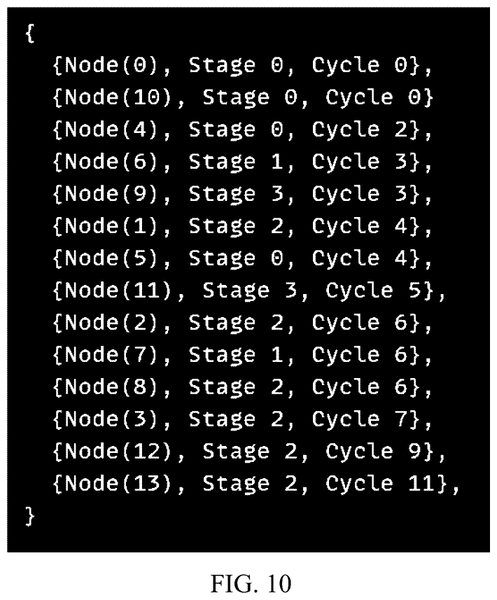

Illustratively, the target scheduling result includes the N instructions and the scheduling success moment of each instruction. Thus, the scheduling success moment of each instruction may be acquired from the target scheduling result, and modulo processing is performed on the scheduling success moment of each instruction, to obtain modulo scheduling information. The modulo scheduling information includes a node sequence number, a stage sequence number, and a beat position that corresponds to each instruction after the scheduling operation is performed. The stage sequence number is configured for indicating a code stage in which a corresponding instruction is located after modulo processing is performed. The beat position is configured for indicating a loop position where a corresponding instruction is located after modulo processing is performed. For example, with the target scheduling result shown in FIG. 9C as an example, FIG. 10 is a schematic diagram of modulo scheduling information according to an embodiment of the present disclosure. As shown in FIG. 10, model information relevant to each instruction may be acquired after modulo processing is performed on the target scheduling result in FIG. 9C. For example, for the first instruction (i.e. the node (12)), it can be acquired from the modulo scheduling information that the corresponding node sequence number is the node (12), the corresponding stage sequence number is a stage 2, and the corresponding beat position is a loop 9. The stage sequence number stage 2 corresponds to the code number S (2) in FIG. 2A. The beat location loop 9 corresponds to the ninth beat in the core stage in FIG. 2A. In this way, after the modulo scheduling information is obtained, the target code program may be generated based on the modulo scheduling information.

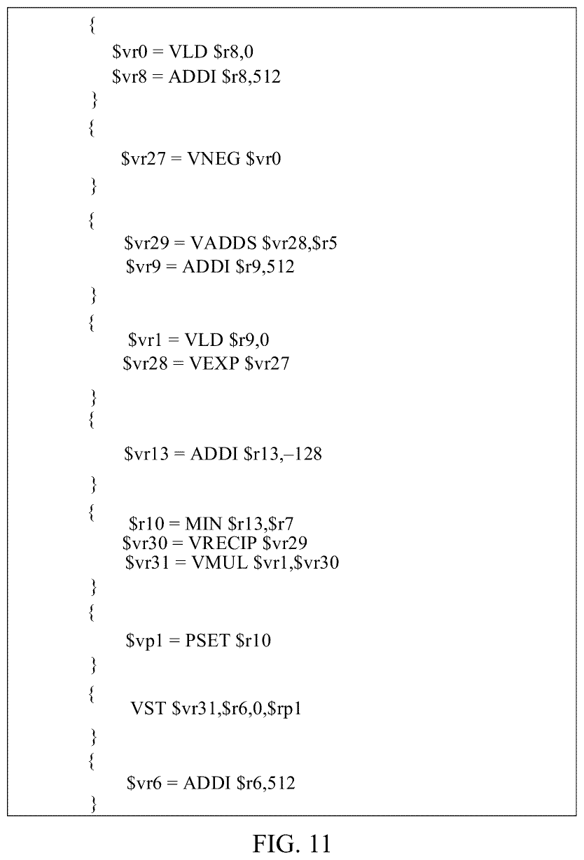

Illustratively, after the target scheduling result is obtained, corresponding instructions undergoing the scheduling operation at a same scheduling moment or may be divided into a same group. Reference can be specifically made to the schematic diagram of a core loop instruction sequence shown in FIG. 11 for understanding the above operation, which will not be repeated herein.

In the embodiments of the present disclosure, the breadth search is performed on the first M instructions in the above mode, and all the scheduling results (i.e. the L sub-scheduling sets) of the first M instructions are recorded. Then, for each sub-scheduling set, the backtracking search continues to be performed on the remaining N-M instructions through one independent first thread, to obtain target search results of the N instructions through the search. To be specific, the N instructions are scheduled by combining the breadth search and the backtracking search. Thus, an instruction search space can be expanded in a case of a limited number of searches, and scheduling performance can be improved. Moreover, one independent first thread is assigned to each sub-scheduling set. Thus, parallelization can be supported in a backtracking search process, and through a multi-thread technology, an instruction scheduling speed can be increased, and instruction scheduling efficiency can be improved.

For example, the comparison between an effect of the scheduling solution of the present disclosure and an effect of a conventional search solution is described below under the same scheduling information from three perspectives of the II in a case of a scheduling success, distribution of the scheduling number, and scheduling time consumption. Reference can be made to the content shown in Table 1 below for understanding the scheduling information.

TABLE 1

| Sequence | | |
|---|---|---|
| number | Parameter name | Value |
| 1 | Number of instructions | 47 |
| 2 | Number M of search layers of | 2 |
| | the breadth search algorithm | |
| 3 | Maximum number K of threads | 24 |
| 4 | Maximum total search number | 6200000 |
| 5 | Number of server cores | 84 |
| 6 | Initial II | 13 |

As can be seen from the above Table 1, test parameters include 47 instructions, the number of search layers of the breadth search algorithm is 2, the maximum number K of threads is equal to 24, the maximum total search number is 6200000, the number of server cores is 84, and the initial initiation interval (II) is 13. To improve instruction parallelism, loop expansion is pre-performed on a core loop of Glu four times.

By comparing the II generated when scheduling of the 47 instructions succeeds according to the scheduling solution of the present disclosure with the II generated when scheduling of the 47 instructions succeeds according to the conventional search solution, results are shown in Table 2 below:

TABLE 2
II in a case of the scheduling success through different algorithms

| Sequence | | II convergence |
|---|---|---|
| number | Algorithm name | value |
| 1 | Scheduling solution of the present disclosure | 19 |
| 2 | Backtracking search algorithm | 20 |

As can be seen from the above Table 2, the II obtained when the scheduling is performed through the scheduling solution of the present disclosure is minimum. Compared with a case of performing the scheduling directly through the backtracking search algorithm, core performance can be improved to the highest extent.

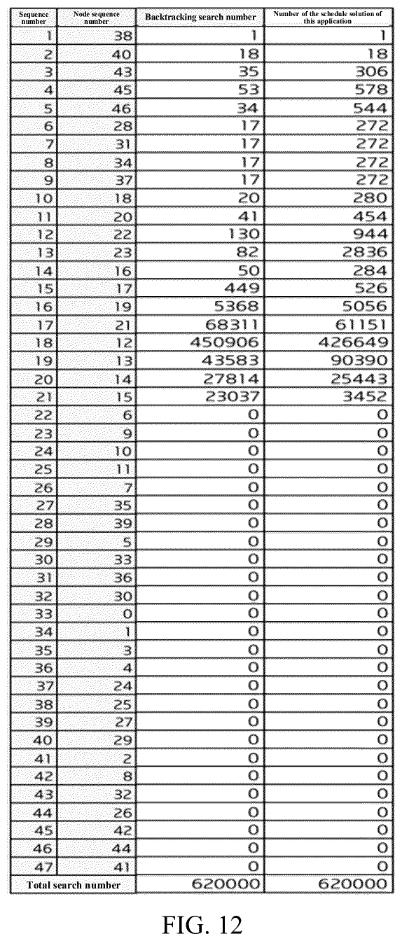

Also, when no target scheduling result is obtained through the scheduling according to the scheduling solution of the present disclosure and the conventional search solution in a case of the II=18, differences in scheduling numbers generated when the instructions are scheduled are compared, and results are shown in the distribution diagram shown in FIG. 12. As shown in FIG. 12, the backtracking search algorithm is limited by algorithm principles, and thus an instruction ranked higher has a smaller number of searches. For example, the third instruction to the fourteenth instruction have a smaller number of searches. However, after scheduling is performed through the scheduling solution of the present disclosure, the number of searches of the instruction ranked higher is significantly greater than that of searches of the backtracking search algorithm. Thus, a larger search space can be covered, and better scheduling performance can be obtained.

In addition, the search time consumption of the scheduling solution of the present disclosure is compared with the search time consumption of the conventional search solution. In the scheduling solution of the present disclosure and the conventional search solution, five consecutive tests are separately performed. Results are shown in Table 3 below:

TABLE 3
Search Time Consumption of Each Algorithm

| | | Scheduling solution |
|---|---|---|
| Test | Backtracking | of the present |
| number | search algorithm | disclosure |
| 1 | 64.024 | 6.313 |
| 2 | 64.372 | 6.735 |
| 3 | 63.757 | 6.864 |
| 4 | 64.788 | 6.564 |
| 5 | 64.746 | 6.763 |
| Average time consumption | 64.3374 | 6.6478 |
| (second) | | |

As can be seen from the above Table 3, the backtracking search algorithm does not support the multi-thread technology, and thus consumes longer time. However, in the scheduling solution of the present disclosure, under each sub-scheduling set, backtracking search processing is performed on the remaining instructions based on the independent thread, to implement acceleration through the multi-thread technology. Thus, only about 10% of time for the backtracking search is consumed, and the search time consumption is greatly shortened.

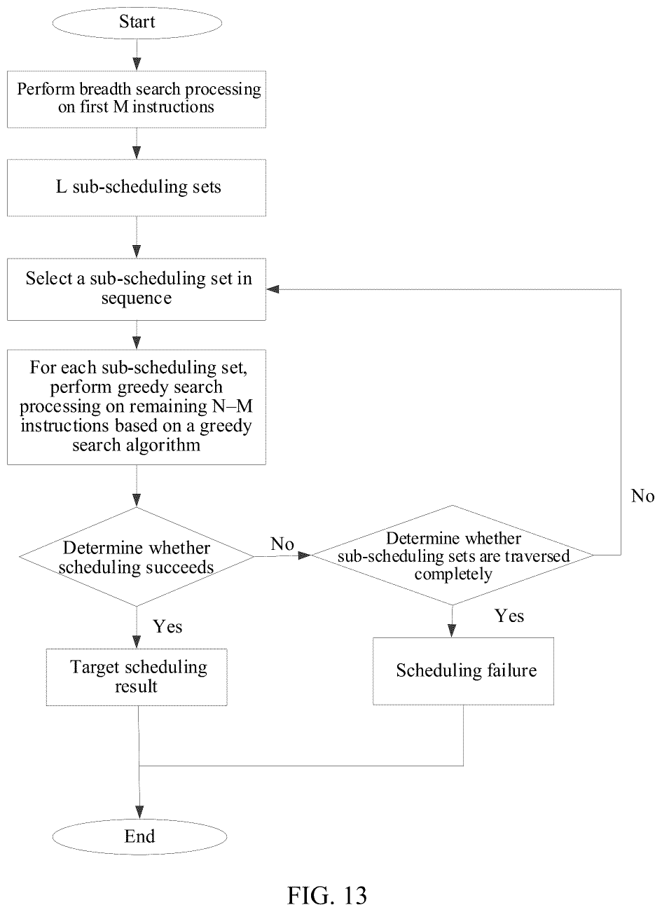

In some other examples, in a scenario that is sensitive to compilation time, or cannot perform the scheduling through the multi-thread technology, the breadth search algorithm and a greedy search algorithm or may be fused. Reference can be specifically made to the flowchart shown in FIG. 13 for understanding a specific scheduling flow.

As shown in FIG. 13, after first instruction sequence and scheduling information are acquired, breadth search processing may be first performed on the scheduling information and first M instructions in the first instruction sequence based on the breadth search algorithm, to obtain L sub-scheduling sets including scheduling results of the first M instructions. Then, after scheduling results of the first M instructions are obtained through the breadth search processing, greedy search processing is performed on the scheduling information and remaining N-M instructions based on the greedy search algorithm in each sub-scheduling set, to obtain a target scheduling result of the first instruction sequence. More specifically, if scheduling of the remaining N-M instructions succeeds, the search is completed, and the target scheduling result is generated. Otherwise, if no scheduling of the remaining N-M instructions succeeds, whether the L sub-scheduling sets are traversed is determined. More specifically, during scheduling of the sub-scheduling sets, if the L sub-scheduling sets are not traversed completely, a next sub-scheduling set is selected, and the instruction continues to be scheduled based on the next sub-scheduling set. If the L sub-scheduling sets are traversed completely, a scheduling failure result is generated. Without the multi-thread technology, greedy search processing is performed in the above mode, and thus search time consumption can be reduced.

Reference can be made to the content shown in FIG. 7 for understanding the first instruction sequence mentioned in FIG. 13, which will not be repeated herein. Also, reference can be made to the content described in FIG. 8A or FIG. 8C for understanding breadth search processing mentioned, which will not be repeated herein. Also, the greedy search algorithm mentioned is an existing algorithm, and a specific search process thereof will not be repeated in the embodiments of the present disclosure.

The solution according to the embodiments of the present disclosure is mainly described above from the perspective of the method. To implement the above functions, corresponding hardware structures and/or software modules configured to perform the functions are included. Those skilled in the art is to readily conceive that in combination with the modules and algorithmic operations in each example described in the embodiments disclosed by the present disclosure, the present disclosure can be implemented in a form of hardware or a combination of hardware and computer software. Whether a particular function is executed by hardware or computer software driven hardware depends on the specific application and design constraint condition of the technical solution. Those skilled in the art can implement the function described through different methods for each specific application, but such an implementation is not to be deemed as falling beyond the scope of the present disclosure.

In the embodiments of the present disclosure, function modules of the apparatus can be divided according to the above method example. For example, the function modules can be divided corresponding to the functions. Alternatively, two or more functions can be integrated in one processing module. The above integrated module can be implemented in the form of hardware or a software function module. In the embodiments of the present disclosure, the module division is illustrative, and the modules are divided merely by logical function. Other division methods can be used in an actual implementation.

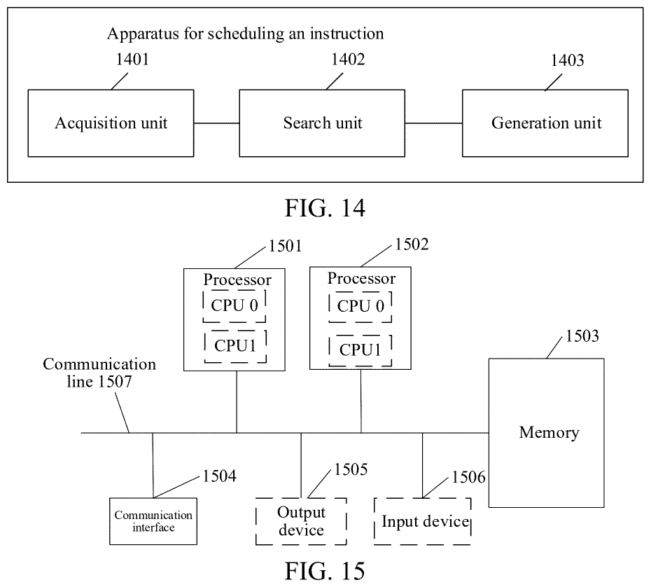

An apparatus for scheduling an instruction in the embodiments of the present disclosure is described in detail below. FIG. 14 is a schematic diagram of an embodiment of the apparatus for scheduling an instruction according to an embodiment of the present disclosure. As shown in FIG. 14, the apparatus for scheduling an instruction may include an acquisition unit 1401, a search unit 1402, and a generation unit 1403.

The acquisition unit 1401 is configured to acquire a first instruction sequence and scheduling information, the first instruction sequence including N instructions, the scheduling information being a scheduling parameter required when a scheduling operation is performed on the N instructions, and N being a positive integer. Reference can be specifically made to the content shown in operation 401 in FIG. 4 for understanding the above operation, which will not be repeated herein.

The search unit 1402 is configured to perform breadth search processing on the scheduling information and first M instructions among the N instructions based on a breadth search algorithm, to obtain L sub-scheduling sets, each sub-scheduling set including scheduling results of the first M instructions, L being a positive integer, and 1≤M<N. Reference can be specifically made to the content shown in operation 402 in FIG. 4 for understanding the above operation, which will not be repeated herein.

The search unit 1402 is further configured to perform backtracking search processing on the scheduling information and remaining N-M instructions among the N instructions in parallel based on a backtracking search algorithm through L first threads in the L sub-scheduling sets, to obtain target scheduling results of the N instructions, the sub-scheduling sets corresponding one-to-one to the first threads. Reference can be specifically made to the content shown in operation 403 in FIG. 4 for understanding the above operation, which will not be repeated herein.

The generation unit 1403 is configured to generate a target code program based on the target scheduling result, the target code program being configured for scheduling the instruction. Reference can be specifically made to the content shown in operation 404 in FIG. 4 for understanding the above operation, which will not be repeated herein.

In some exemplary examples, the scheduling information includes a directed edge weight and an initiation interval, the directed edge weight being configured for indicating a number of delayed beats between every two instructions among the N instructions, and the initiation interval being configured for indicating execution interval time generated when the scheduling operation is performed on every two adjacent instructions separately.

In some other exemplary examples, the search unit 1402 is configured to determine one or more first sub-scheduling results, each first sub-scheduling result being a result generated when the scheduling operation on first M-1 instructions succeeds, and each first sub-scheduling result including the first M-1 instructions and a scheduling success moment of each instruction among the first M-1 instructions. The search unit 1402 is configured to: compute a scheduling time window of an M^{th} instruction under each first sub-scheduling result based on scheduling success moments of the first M-1 instructions in each first sub-scheduling result and the initiation interval; and traverse each first scheduling moment in the scheduling time window of the M^{th} instruction under a first result in sequence, and perform the scheduling operation on the M^{th} instruction at each first scheduling moment, the first result being any one of the one or more first sub-scheduling results. The generation unit 1403 is configured to generate a second scheduling result when the scheduling operation on the M^{th} instruction at a first target scheduling moment succeeds, to obtain L sub-scheduling sets, the second scheduling result including the first M instructions and a scheduling success moment of each instruction among the first M instructions, and the first target scheduling moment being one or more first scheduling moments in the scheduling time window of the M^{th} instruction.

In yet some other exemplary examples, the search unit 1402 is further configured to: traverse a second result after the scheduling operation is performed on the M^{th} instruction at each first scheduling moment and when the scheduling operation on the M^{th} instruction at the first target scheduling moment fails, the second result being any one of the one or more first sub-scheduling results and different from the first result; and traverse each second scheduling moment in the scheduling time window of the M^{th} instruction under a second result in sequence, and perform the scheduling operation on the M^{th} instruction at each second scheduling moment. The generation unit 1403 is configured to generate a second scheduling result when the scheduling operation on the M^{th} instruction at a second target scheduling moment succeeds, the second target scheduling moment being one or more second scheduling moments in the scheduling time window of the M^{th} instruction.

In yet some other exemplary examples, the search unit 1402 is configured to: determine one or more first instructions and one or more second instructions from the first M-1 instructions, each first instruction pointing to the M^{th} instruction in a directed acyclic graph, and the M^{th} instruction pointing to each second instruction in the directed acyclic graph; determine a first value based on a scheduling success moment of the one or more first instructions and a first directed edge weight, the first directed edge weight being a directed edge weight between each first instruction and the M^{th} instruction; determine a second value based on a scheduling success moment of the one or more second instructions and a second directed edge weight, the second directed edge weight being a directed edge weight between each second instruction and the M^{th} instruction; and take the first value and the second value as an initial value and an end value of the scheduling time window of the M^{th} instruction under the first result, to obtain the scheduling time window of the M^{th} instruction under the first result.

In yet some other exemplary examples, the search unit 1402 is configured to: sum a scheduling success moment of each first instruction and a corresponding first directed edge weight, to obtain at least one first moment; and select a maximum moment from the at least one first moment as the first value.

In yet some other exemplary examples, the search unit 1402 is configured to: obtain a difference value between a scheduling success moment of each second instruction and a corresponding second directed edge weight, to obtain at least one second moment; and select a minimum moment from the at least one second moment as the second value.

In yet some other exemplary examples, the search unit 1402 is configured to: determine, when no scheduling operation on another instruction among the M instructions at the first target scheduling moment succeeds, that the scheduling operation on the M^{th} instruction at the first target scheduling moment succeeds.

In yet some other exemplary examples, the search unit 1402 is configured to: for each sub-scheduling set, traverse the remaining N-M instructions based on corresponding first threads in sequence, and compute a scheduling time window of each instruction among the N-M instructions; for each sub-scheduling set, traverse each third scheduling moment in the scheduling time window of each instruction among the N-M instructions based on the corresponding first threads in sequence, and perform the scheduling operation on the corresponding instruction at each third scheduling moment; for each sub-scheduling set, perform, if no scheduling operation on a Q^{th} instruction at each third scheduling moment in a scheduling time window of the Q^{th} instruction succeeds, backtracking to a (Q-1)^{th} instruction based on the first thread, and acquire context information of the (Q-1)^{th} instruction, M<Q≤N; and for each sub-scheduling set, re-compute a scheduling time window of the (Q-1)^{th} instruction for the (Q-1)^{th} instruction based on the context information of the (Q-1)^{th} instruction until the scheduling operation on the Q^{th} instruction at any third scheduling moment in the scheduling time window of the Q^{th} instruction succeeds, to obtain the target scheduling results of the N instructions.

In yet some other exemplary examples, the search unit 1402 is configured to: take, if a second thread succeeds in performing the scheduling operation on the remaining N-M instructions under a corresponding sub-scheduling set, a scheduling result of the second thread under the corresponding sub-scheduling set as the target scheduling results of the N instructions, and stop performing, by a third thread, the scheduling operation on the remaining N-M instructions,

the second thread being a thread that succeeds in performing the scheduling operation on the remaining N-M instructions in the first thread, and the third thread being another thread in the first thread other than the second thread.

In yet some other examples, the acquisition unit 1401 is further configured to acquire a first total scheduling number, the first total scheduling number being a total scheduling number by which the corresponding first thread performs the scheduling operation on the remaining N-M instructions in the first sub-scheduling set, and the first sub-scheduling set being any one of the L sub-scheduling sets. The search unit 1402 is configured to determine, when the first total scheduling number is greater than or equal to a preset threshold, that no corresponding first thread succeeds in performing the scheduling operation on the remaining N-M instructions, to obtain a failure result as the target scheduling result of the corresponding first thread under the first sub-scheduling set.

In yet some other exemplary examples, the acquisition unit 1401 is configured to: acquire a scheduling success moment of each instruction from the target scheduling result. The generation unit 1403 is configured to: perform modulo processing on the scheduling success moment of each instruction, to obtain modulo scheduling information, the modulo scheduling information including a node sequence number, a stage sequence number, and a beat position that corresponds to each instruction after the scheduling operation is performed, the stage sequence number being configured for indicating a code stage in which a corresponding instruction is located after modulo processing is performed, and the beat position being configured for indicating a loop position where the corresponding instruction is located after modulo processing is performed; and generate the target code program based on the modulo scheduling information.

In yet some other exemplary examples, the acquisition unit 1401 is configured to acquire a second instruction sequence transmitted by a front-end processor. The search unit 1402 is configured to re-rank instructions in the second instruction sequence, to obtain the first instruction sequence.

In yet some other exemplary examples, the search unit 1402 is configured to: construct a directed acyclic graph based on the second instruction sequence, the directed acyclic graph including N nodes and a directed edge weight between the nodes, the node being configured for indicating the instruction, and the directed edge weight being configured for indicating an initiation interval between instructions corresponding to every two nodes; and re-rank the second instruction sequence based on the scheduling information and the directed acyclic graph, to obtain the first instruction sequence.

In yet some other exemplary examples, a value of M is equal to a number of search layers of the breadth search algorithm.

The apparatus for scheduling an instruction in the embodiments of the present disclosure is described above from the perspective of modular function entities. A device for scheduling an instruction in the embodiments of the present disclosure is described below from the perspective of hardware processing. FIG. 15 is a schematic structural diagram of a device for scheduling an instruction according to an embodiment of the present disclosure. The device for scheduling an instruction may vary significantly due to different configurations or performance. The device may be a server, a compiler, a device on which a compiler is deployed, or the apparatus for scheduling an instruction described in FIG. 14. The device for scheduling an instruction may include at least one processor 1501, a communication line 1507, a memory 1503, and at least one communications interface 1504.

The processor 1501 may be a general-purpose central processing unit (CPU), a microprocessor, an application-specific integrated circuit (ASIC), a server IC, or one or more integrated circuits configured to control execution of programs in the solution of the present disclosure.

The communication line 1507 may include a path configured to transmit information among the above components.

The communication interface 1504 communicates with another apparatus or a communication network such as an Ethernet, a radio access network (RAN), and a wireless local area network (WLAN) through any apparatus of a transceiver type.

The memory 1503 can be a read-only memory (ROM), another type of static storage apparatus that can store static information and instructions, a random access memory (RAM), or another type of dynamic storage apparatus that can store information and instructions. The memory can be independent and connected to the processor via communication line 1507. The memory and the processor or can be integrated together.

The memory 1503 is configured to store computer-executable instructions for executing the solution of the present disclosure, and controlled by the processor 1501 for execution. The processor 1501 is configured to execute the computer-executable instructions stored in the memory 1503, to implement the method for scheduling an instruction according to the above embodiments of the present disclosure.

In some embodiments, the computer-executable instructions in the embodiments of the present disclosure or can be referred to as application codes, which is not specifically limited in the embodiments of the present disclosure.

In a specific implementation, as one embodiment, the device for scheduling an instruction can include a plurality of processors, for example, a processor 1501 and a processor 1502 in FIG. 15. The processor herein can indicate one or more apparatuses, circuits, and/or processing cores configured to process data (for example, computer program instructions).

In a specific implementation, as one embodiment, the device for scheduling an instruction can further include an output device 1505 and an input device 1506. The output device 1505 communicates with the processor 1501, and can display information in a plurality of modes. The input device 1506 communicates with the processor 1501, and can receive an input by a target object in a plurality of modes. For example, the input device 1506 can be a mouse, a touch screen apparatus, or a sensing apparatus.

The above device for scheduling an instruction can be a general-purpose apparatus or a special-purpose apparatus. In a specific implementation, the device for scheduling an instruction can be a server, a terminal, or an apparatus having a structure similar to that shown in FIG. 15. The type of the device for scheduling an instruction is not limited in the embodiments of the present disclosure.

The processor 1501 in FIG. 15 can invoke the computer-executable instruction stored in the memory 1503, to cause the device for scheduling an instruction to execute the methods in the method embodiments corresponding to FIG. 4 to FIG. 13.

Specifically, functions/implementation processes of the search unit 1402 and the generation unit 1403 in FIG. 14 can be implemented by the processor 1501 in FIG. 15 by invoking the computer-executable instructions stored in the memory 1503. A function/implementation process of the acquisition unit 1401 in FIG. 14 can be implemented through the communications interface 1504 in FIG. 15.

A computer storage medium is further provided in the embodiments of the present disclosure. The computer storage medium has a computer program configured for electronic data interchange stored therein. The computer program causes a computer to perform some or all operations of any method for scheduling an instruction described in the above method embodiments.

A computer program product is further provided in the embodiments of the present disclosure. The computer program product includes a non-transitory computer-readable storage medium having a computer program stored therein. The computer program is operable to cause a computer to perform some or all operations of any method for scheduling an instruction described in the above method embodiments.

In the above embodiments, all or some of the operations may be implemented through software, hardware, firmware, or their any combinations. When the operations are implemented through software, all or some of the operations may be implemented in a form of a computer program product.

The embodiments of the present disclosure have the advantages as follows. For example, since the scheduling information is the scheduling parameter required when the scheduling operation is performed on the N instructions in the first instruction sequence, after the first instruction sequence and the scheduling information are acquired, breadth search processing may be first performed on the scheduling information and the first M instructions among the N instructions based on the breadth search algorithm, to obtain the L sub-scheduling sets. Each sub-scheduling set includes the scheduling results of the first M instructions. Further, backtracking search processing is performed on the scheduling information and the remaining N-M instructions among the N instructions in parallel based on the backtracking search algorithm through the L first threads in the L sub-scheduling sets, to obtain the target scheduling results of the N instructions. Each sub-scheduling set corresponds to any one of the first threads. In this way, after the target scheduling result is obtained through search processing, the target code program is generated based on the target scheduling result, to scheduling the instruction through the target code program. A breadth search is first performed on the first M instructions in the above mode, and all the scheduling results (i.e. the L sub-scheduling sets) of the first M instructions are recorded. Then, for each sub-scheduling set, a backtracking search continues to be performed on the remaining N-M instructions through one independent first thread. Thus, target search results of the N instructions are obtained by performing a parallel search through the L first threads. To be specific, the N instructions are scheduled by combining the breadth search and the backtracking search. Thus, an instruction search space can be expanded in a case of a limited number of searches, and scheduling performance can be improved. Moreover, one independent first thread is assigned to each sub-scheduling set. Thus, parallelization can be supported in a backtracking search process, and an instruction scheduling speed can be increased through a multi-thread technology.

Those skilled in the art can clearly understand that for convenience and conciseness of description, reference can be made to the corresponding processes in the above method embodiments for specific working processes of the above system, apparatus, and unit, which will not be repeated herein.

In several embodiments provided in the present disclosure, the system, apparatus, and method disclosed may be implemented in other modes. For example, the apparatus embodiments described above are merely illustrative. For example, the units are divided merely by logical function. Other division methods can be used in an actual implementation. For example, a plurality of units or components can be combined or integrated into another system, or some features can be ignored or not performed. In addition, mutual coupling or direct coupling, or communication connection displayed or discussed can be implemented through some interfaces. Indirect coupling or communication connection between the apparatuses or units can be electronic, mechanical, etc.

The units described as separate parts can be physically separated or not. Parts displayed as units can be physical units or not. To be specific, the parts can be located in one place or distributed over a plurality of network units. Some or all of the units can be selected according to actual needs to achieve the objectives of the solution in the embodiment.

Also, each function units in the embodiments of the present disclosure can be integrated into one processing unit. Alternatively, each unit can be physically separated. Alternatively, two or more units can be integrated into one unit. The above integrated unit can be implemented in a form of hardware or a software function unit.

When implemented in the form of the software function unit and sold or used as an independent product, the integrated unit can be stored in one computer-readable storage medium. Based on such understanding, the technical solution of the present disclosure essentially, or the part contributing to the related art, or all or some of the technical solution can be embodied in a form of a software product. The computer software product is stored in one storage medium and includes several instructions configured for causing a computer device (which can be a personal computer, a server, a network device, etc.) to perform all or some of the operations of the method in each embodiment of the present disclosure. The above storage medium includes: various media that can store program codes, such as a universal serial bus (USB) flash disk, a removable hard disk, a read-only memory (ROM), a random access memory (RAM), a magnetic disk, and an optical disk.

All or some of the above embodiments can be implemented through software, hardware, firmware, or their any combinations. When implemented through the software, all or some of the embodiments can be implemented in a form of a computer program product.

The computer program product includes one or more computer instructions. When loaded and executed on a computer, all or some of the computer-executable instructions generate the flows or functions according to the embodiments of the present disclosure. The computer can be a general-purpose computer, a special-purpose computer, a computer network, or another programmable apparatus. The computer instructions can be stored in a computer-readable storage medium or transmitted from one computer-readable storage medium to another computer-readable storage medium. For example, the computer instructions can be transmitted from a website, computer, server, or data center to another website, computer, server, or data center through a wired means (for example, a coaxial cable, an optical fiber, and a digital subscribe line (DSL)), or a wireless means (for example, infrared, radio waves, and microwaves). The computer-readable storage medium can be any available medium that the computer can access, or an integrated server, data center, etc. that encompasses one or more available media. The available medium can be a magnetic medium (for example, a floppy disk, a hard disk, and a magnetic tape), an optical medium (for example, a digital video disk (DVD)), a semiconductor medium (for example, a solid state drive (SSD)), etc.

The above embodiments are merely used for describing the technical solution of the present disclosure, but do not limit the technical solution of the present disclosure. Although the present disclosure is described in detail with reference to the above embodiments, those of ordinary skill in the art is to understand that modifications can still be made to the technical solution described in the above embodiments, or equivalent replacements can also be made to some technical features in the above embodiments. Such modifications or replacements do not cause the essence of the corresponding technical solution to depart from the spirit and scope of the technical solution in each embodiment of the present disclosure.

What is claimed is:

1. A method for scheduling an instruction, comprising:
acquiring a first instruction sequence and scheduling information, the first instruction sequence comprising N instructions, the scheduling information being a scheduling parameter required for performing a scheduling operation on the N instructions, and N being a positive integer;
performing breadth search processing on the scheduling information and first M instructions among the N instructions based on a breadth search algorithm, to obtain L sub-scheduling sets, each sub-scheduling set comprising scheduling results of the first M instructions, L being a positive integer, and 1≤M<N;
performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and
generating a target code program based on the target scheduling results, the target code program being configured for scheduling the instructions.

2. The method according to claim 1, wherein the scheduling information comprises a directed edge weight and an initiation interval, the directed edge weight being configured for indicating a number of delayed beats between every two instructions among the N instructions, and the initiation interval being configured for indicating execution interval time generated when the scheduling operation is performed on every two adjacent instructions separately.

3. The method according to claim 2, wherein performing the breadth search processing on the scheduling information and the first M instructions among the N instructions based on the breadth search algorithm, to obtain the L sub-scheduling sets comprises:
determining one or more first sub-scheduling results, each first sub-scheduling result being a result obtained when the scheduling operation on first M-1 instructions succeeds, and a first sub-scheduling result comprising the first M-1 instructions and a scheduling success moment of each instruction among the first M-1 instructions;
computing a scheduling time window of an M^{th} instruction under each first sub-scheduling result based on the scheduling success moments of the first M-1 instructions in each first sub-scheduling result and the directed edge weight;
traversing each first scheduling moment in the scheduling time window of the M^{th} instruction under a first result in sequence, and performing the scheduling operation on the M^{th} instruction at each first scheduling moment, the first result being any one of the one or more first sub-scheduling results; and
generating a second scheduling result when the scheduling operation on the M^{th} instruction at a first target scheduling moment succeeds, to obtain the L sub-scheduling sets, the second scheduling result comprising the first M instructions and a scheduling success moment of each instruction among the first M instructions, and the first target scheduling moment being one or more first scheduling moments in the scheduling time window of the M^{th} instruction.

4. The method according to claim 3, further comprising:
traversing a second result when the scheduling operation on the M^{th} instruction at the first target scheduling moment fails, the second result being any one of the one or more first sub-scheduling results and different from the first result; and
traversing each second scheduling moment in the scheduling time window of the M^{th} instruction under the second result in sequence, and performing the scheduling operation on the M^{th} instruction at each second scheduling moment; and
generating the second scheduling result when the scheduling operation on the M^{th} instruction at the first target scheduling moment succeeds comprises:
generating the second scheduling result when the scheduling operation on the M^{th} instruction at a second target scheduling moment succeeds, the second target scheduling moment being one or more second scheduling moments in the scheduling time window of the M^{th} instruction.

5. The method according to claim 3, wherein computing the scheduling time window of the M^{th} instruction under each first sub-scheduling result based on the scheduling success moments of the first M-1 instructions in each first sub-scheduling result and the directed edge weight comprises:
determining one or more first instructions and one or more second instructions from the first M-1 instructions, each first instruction pointing to the M^{th} instruction in a directed acyclic graph, and the M^{th} instruction pointing to each second instruction in the directed acyclic graph;
determining a first value based on a scheduling success moment of the one or more first instructions and a first directed edge weight, the first directed edge weight being a directed edge weight between each first instruction and the M^{th} instruction;
determining a second value based on a scheduling success moment of the one or more second instructions and a second directed edge weight, the second directed edge weight being a directed edge weight between each second instruction and the M^{th} instruction; and
taking the first value and the second value as an initial value and an end value of the scheduling time window of the M^{th} instruction under the first result, to obtain the scheduling time window of the M^{th} instruction under the first result.

6. The method according to claim 5, wherein determining the first value based on the scheduling success moment of the one or more first instructions and the first directed edge weight comprises:
summing a scheduling success moment of each first instruction and a corresponding first directed edge weight, to obtain at least one first moment; and
selecting a maximum moment from the at least one first moment as the first value.

7. The method according to claim 5, wherein determining the second value based on the scheduling success moment of the one or more second instructions and the second directed edge weight comprises:
obtaining a difference value between a scheduling success moment of each second instruction and a corresponding second directed edge weight, to obtain at least one second moment; and
selecting a minimum moment from the at least one second moment as the second value.

8. The method according to claim 3, wherein the scheduling operation is successfully performed on the M^{th} instruction at the first target scheduling moment by:
determining, when no scheduling operation on another instruction among the M instructions at the first target scheduling moment succeeds, that the scheduling operation on the M^{th} instruction at the first target scheduling moment succeeds.

9. The method according to claim 2, wherein performing the backtracking search processing in parallel on the scheduling information and the remaining N-M instructions among the N instructions based on the backtracking search algorithm through L first threads in the L sub-scheduling sets, to obtain the target scheduling results of the N instructions comprises:
for each sub-scheduling set, traversing the remaining N-M instructions based on corresponding first threads in sequence, and computing a scheduling time window of each instruction among the N-M instructions;
for each sub-scheduling set, traversing each third scheduling moment in the scheduling time window of each instruction of the N-M instructions based on the corresponding first threads in sequence, and performing the scheduling operation on a corresponding instruction at each third scheduling moment;
for each sub-scheduling set, performing, if no scheduling operation on a Q^{th} instruction at each third scheduling moment in a scheduling time window of the Q^{th} instruction succeeds, backtracking to a (Q-1)^{th} instruction based on the first thread, and acquiring context information of the (Q-1)^{th} instruction, M<Q≤N; and
for each sub-scheduling set, re-computing a scheduling time window of the (Q-1)^{th} instruction for the (Q-1)^{th} instruction based on the context information of the (Q-1)^{th} instruction until the scheduling operation on the Q^{th} instruction at any third scheduling moment in the scheduling time window of the Q^{th} instruction succeeds, to obtain the target scheduling results of the N instructions.

10. The method according to claim 9, wherein the obtaining of the target scheduling results of the N instructions comprises:
taking, when a second thread succeeds in performing the scheduling operation on the remaining N-M instructions under a corresponding sub-scheduling set, a scheduling result of the second thread under the corresponding sub-scheduling set as the target scheduling results of the N instructions, and stopping performing, by a third thread, the scheduling operation on the remaining N-M instructions,
the second thread being a thread in the first thread and succeeding in performing the scheduling operation on the remaining N-M instructions, and the third thread being a thread in the first thread other than the second thread.

11. The method according to claim 9, further comprising:
acquiring a first total scheduling number, the first total scheduling number being a total scheduling number by which the corresponding first thread performs the scheduling operation on the remaining N-M instructions in the first sub-scheduling set, and the first sub-scheduling set being any one of the L sub-scheduling sets; and
determining, when the first total scheduling number is greater than or equal to a preset threshold, that no corresponding first thread succeeds in performing the scheduling operation on the remaining N-M instructions, to obtain a failure result as the target scheduling result of the corresponding first thread under the first sub-scheduling set.

12. The method according to claim 1, wherein generating the target code program based on the target scheduling results comprises:
acquiring a scheduling success moment of each instruction from the target scheduling result;
performing modulo processing on the scheduling success moment of each instruction, to obtain modulo scheduling information, the modulo scheduling information comprising a node sequence number, a stage sequence number, and a beat position that corresponds to each instruction after the scheduling operation is performed, the stage sequence number being configured for indicating a code stage in which a corresponding instruction is located after modulo processing is performed, and the beat position being configured for indicating a loop position where the corresponding instruction is located after modulo processing is performed; and
generating the target code program based on the modulo scheduling information.

13. The method according to claim 1, wherein acquiring the first instruction sequence comprises:
acquiring a second instruction sequence transmitted by a front-end processor; and
re-ranking instructions in the second instruction sequence, to obtain the first instruction sequence.

14. The method according to claim 13, wherein re-ranking the instructions in the second instruction sequence, to obtain the first instruction sequence comprises:
constructing a directed acyclic graph based on the second instruction sequence, the directed acyclic graph comprising N nodes and a directed edge weight between the nodes, and the node being configured for indicating the instruction; and
re-ranking the second instruction sequence based on the scheduling information and the directed acyclic graph, to obtain the first instruction sequence.

15. The method according to claim 1, wherein a value of M is equal to a number of search layers of the breadth search algorithm.

16. A device for scheduling an instruction, comprising:
an input/output interface, one or more processors, and a memory containing a computer program that, when being executed, causes the one or more processors to perform:
acquiring a first instruction sequence and scheduling information, the first instruction sequence comprising N instructions, the scheduling information being a scheduling parameter required for performing a scheduling operation on the N instructions, and N being a positive integer;
performing breadth search processing on the scheduling information and first M instructions among the N instructions based on a breadth search algorithm, to obtain L sub-scheduling sets, each sub-scheduling set comprising scheduling results of the first M instructions, L being a positive integer, and 1≤M<N;
performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and
generating a target code program based on the target scheduling results, the target code program being configured for scheduling the instructions.

17. The device according to claim 16, wherein the scheduling information comprises a directed edge weight and an initiation interval, the directed edge weight being configured for indicating a number of delayed beats between every two instructions among the N instructions, and the initiation interval being configured for indicating execution interval time generated when the scheduling operation is performed on every two adjacent instructions separately.

18. The device according to claim 17, wherein the one or more processors are further configured to perform:
determining one or more first sub-scheduling results, each first sub-scheduling result being a result obtained when the scheduling operation on first M-1 instructions succeeds, and a first sub-scheduling result comprising the first M-1 instructions and a scheduling success moment of each instruction among the first M-1 instructions;
computing a scheduling time window of an M^{th} instruction under each first sub-scheduling result based on the scheduling success moments of the first M-1 instructions in each first sub-scheduling result and the directed edge weight;
traversing each first scheduling moment in the scheduling time window of the M^{th} instruction under a first result in sequence, and performing the scheduling operation on the M^{th} instruction at each first scheduling moment, the first result being any one of the one or more first sub-scheduling results; and
generating a second scheduling result when the scheduling operation on the M^{th} instruction at a first target scheduling moment succeeds, to obtain the L sub-scheduling sets, the second scheduling result comprising the first M instructions and a scheduling success moment of each instruction among the first M instructions, and the first target scheduling moment being one or more first scheduling moments in the scheduling time window of the M^{th} instruction.

19. The device according to claim 18, wherein the one or more processors are further configured to perform:
traversing a second result when the scheduling operation on the M^{th} instruction at the first target scheduling moment fails, the second result being any one of the one or more first sub-scheduling results and different from the first result;
traversing each second scheduling moment in the scheduling time window of the M^{th} instruction under the second result in sequence, and performing the scheduling operation on the M^{th} instruction at each second scheduling moment; and
generating the second scheduling result when the scheduling operation on the M^{th} instruction at a second target scheduling moment succeeds, the second target scheduling moment being one or more second scheduling moments in the scheduling time window of the M^{th} instruction.

20. A non-transitory computer-readable storage medium containing a computer program that, when being executed, causes at least one processor of a computer device to perform:
acquiring a first instruction sequence and scheduling information, the first instruction sequence comprising N instructions, the scheduling information being a scheduling parameter required for performing a scheduling operation on the N instructions, and N being a positive integer;
performing breadth search processing on the scheduling information and first M instructions among the N instructions based on a breadth search algorithm, to obtain L sub-scheduling sets, each sub-scheduling set comprising scheduling results of the first M instructions, L being a positive integer, and 1≤M<N;
performing backtracking search processing in parallel on the scheduling information and remaining N-M instructions among the N instructions based on a backtracking search algorithm through L first threads in the L sub-scheduling sets, to obtain target scheduling results of the N instructions, the sub-scheduling sets corresponding one-to-one to the first threads; and
generating a target code program based on the target scheduling results, the target code program being configured for scheduling the instructions.
